(19) United States
(12) Patent Application Publication
(10) Pub. No.: US 2025/0323766 A1
(43) Pub. Date: Oct. 16, 2025

(54) MULTIPATH MITIGATION, INTERFERENCE CANCELLATION AND MULTILATERATION IN A CELLULAR NETWORK SUPPORTING ACCURATE AND RESILIENT PNT SERVICES

(71) Applicant: NextNav France, Puteaux (FR)

(72) Inventors: Rabih CHRABIEH, Montrouge (FR); Minh HOANG, Torcy (FR); Vinh Hoang Son LE, Massy (FR)

(21) Appl. No.: 19/178,807

(22) Filed: Apr. 14, 2025

Related U.S. Application Data
(60) Provisional application No. 63/633,955, filed on Apr. 15, 2024.
(60) Provisional application No. 63/664,362, filed on Jun. 26, 2024.

(51) Int. Cl. H04L 5/00; H04L 27/26; H04W 64/00

(52) U.S. Cl. CPC H04L 5/0007; H04L 27/2651; H04L 27/2665; H04L 27/2691; H04W 64/006

(57) ABSTRACT

Systems, methods, devices, and means for multipath mitigation, interference cancellation and multilateration in a cellular network supporting accurate and resilient position, navigation, and timing (PNT) services are described. The techniques described herein include operations directed to processing positioning reference signals (PRSs) to determine time of arrival (TOA) measurements for determining user equipment (UE) position in the presence of multipath noise and interferences. Example operations associated with processing PRSs includes receiving one or more PRSs in accordance with a comb pattern via resources defined by a set of orthogonal frequency division multiplexing (OFDM) symbols and a set of subcarriers. The example operations include generating a single OFDM symbol comprising the set of subcarriers based on combining the set of OFDM symbols into the single OFDM symbol. The example operations further include performing a multipath mitigation operation using the single OFDM symbol.

### CROSS-REFERENCE TO RELATED APPLICATIONS

This application claims the benefit of U.S. Provisional Application No. 63/633,955, filed Apr. 15, 2024, and U.S. Provisional Application No. 63/664,362, filed Jun. 26, 2024, the contents of which are herein incorporated by reference in their entireties for all purposes.

### FIELD

This disclosure relates to wireless communication network capabilities.

### BACKGROUND

Cellular network signals have been used in the past for estimating the position and timing of user equipment. Various methods have been used to determine position or extract timing from cellular signals including the use of cellular signal strength and time-of-arrival based methods on reference/pilot signals. Dedicated positioning signals such as positioning reference signals (PRS) have been incorporated into cellular standards such as long-term evolution (LTE) and fifth generation (5G) new radio (NR). However, using these dedicated positioning signals to determine accurate position and time is challenging while maintaining the primary purpose (e.g., voice and data capacity) of the cellular network. Another challenge is to obtain this performance in a resilient manner including reliability metrics such as integrity, continuity, and availability. The accuracy and reliability of position and time estimation are critical, especially in applications like navigation, emergency services, and location-based services as well as in critical infrastructure applications.

### BRIEF DESCRIPTION OF THE DRAWING

FIG. 1 illustrates an example of a network in accordance with one or more implementations described herein.

FIGS. 2A and 2B illustrate examples of a network in accordance with one or more implementations described herein.

FIG. 3 illustrates an example of a signaling diagram in accordance with one or more implementations described herein.

FIG. 4 illustrates an example of a resource timeline in accordance with one or more implementations described herein.

FIG. 5 illustrates an example of a signaling diagram in accordance with one or more implementations described herein.

FIG. 6 illustrates example comb patterns in accordance with one or more implementations described herein.

FIG. 7 illustrates an example signaling structure in accordance with one or more implementations described herein.

FIG. 8 illustrates an example signaling construction in accordance with one or more implementations described herein.

FIG. 9 illustrates an example signal sequence in accordance with one or more implementations described herein.

FIG. 10 illustrates an example of I/Q constellation phase rotations in accordance with one or more implementations described herein.

FIG. 11 illustrates an example process for using network assistance data to qualify time of arrival measurements for position estimation in accordance with one or more implementations described herein.

FIG. 12 illustrates an example of a device diagram in accordance with one or more implementations described herein.

FIG. 13 illustrates an example of a process that supports multipath mitigation, interference cancellation and multilateration in a cellular network supporting accurate and resilient position, navigation, and timing (PNT) services in accordance with one or more implementations described herein.

### DETAILED DESCRIPTION

Determining accurate location or timing from cellular signals (e.g., positioning reference signals (PRSs)) poses various challenges, including fine synchronization between transmissions from network entities (e.g., base stations, transmission reception points (TRPs)), which may not be required for wireless communication (e.g., cellular voice/data) services. In some cases, for a resilient positioning, navigation, and timing (PNT) in the context of synchronization, the synchronization may be fine and resilient (e.g., resilient to outages from global positioning system (GPS)). In some cases, such as for timing applications, the PRSs may provide an indication of coordinated universal time (UTC) and, in some cases, have verifiable traceability to UTC. While cellular signals, being terrestrial, may be more resilient than satellite signals (e.g. from GPS and LEO (Low Earth Orbit) to jamming and spoofing due to higher signal strengths, additional mechanisms may be included in the cellular system. Terrestrial systems also have a fundamental near-far problem for multilateration which is generally overcome using a combination of interference reduction techniques based on concepts from multiple access schemes such as time division multiple access (TDMA), code-division multiple access (CDMA), and frequency division multiple access (FDMA). Such techniques are included in dedicated positioning signals in cellular systems, such as PRS, but the choice of configurations of these signals at a PNT network level to enable high-quality PNT may need special attention. One other consideration is to implement these techniques while re-using the existing ecosystem of network entities (e.g., base stations, TRPs) and user equipment (UE) as much as possible.

Dedicated wide-area terrestrial systems (e.g., NextNav LLC's TERRAPOINT or Terrestrial Beacon System (TBS), as disclosed in ATIS contribution “ESIF-ESM-2015-0038R001 MBS-ICD”) for PNT purposes have overcome some of the above challenges through a variety of techniques. The proposed system disclosed herein translates accurate and resilient PNT techniques from such a dedicated system into a cellular system and combines with the capabilities of a cellular system to create a high-accuracy PNT solution that may be used for a variety of applications.

Determining an accurate location of a UE, such as a mobile device (e.g., a phone, laptop computer, tablet, or another device), in an environment may be quite challenging, especially when the UE is located in an urban environment or is located within a building. Multilateration involves solving a set of mathematical equations derived from the distances between the UE and each of the known transmit points. These distances are typically calculated based on the time of arrival (TOA), time difference of arrival (TDOA), or received signal strength (RSS) of the signals (for example, reference signals in a cellular system) emitted by transmitters. In some applications, imprecise estimates of the UE's position may have significant consequences for the corresponding user. For example, an imprecise position estimate of a UE, such as a mobile phone operated by a user calling emergency services, may delay emergency personnel response times. In less dire situations, imprecise estimates of the UE's position may negatively impact navigation applications by directing a user to the wrong location or taking too long to provide accurate directions. Various signal processing techniques are developed for estimating accurate time of arrival as well as for multilateration for the dedicated PRSs. In addition, given the connectivity available to the UE through a cellular network, various additional techniques using assistance information (e.g. indoor/outdoor maps, signal quality information) may be used to further improve performance.

While such a cellular system may operate using the positioning signals (e.g., PRSs) on the downlink (DL) and has the advantage of unlimited user capability, since the users only need to listen to the dedicated positioning signals, the availability of uplink (UL) capability may be taken advantage of in certain positioning use cases as well. For example, positioning signals in the UL (e.g., sounding reference signals (SRS) in LTE and/or 5G), could be used to compute round-trip timing with multiple network entities enabling position computation using these round-trip-measurements without fine synchronization of the transmitters. Another application could be the use of these UL signals in a tightly synchronized network to enable the computation of ranges and positions on the network (e.g., using UL-TDOA).

Such a cellular PNT system may be frequency agnostic (e.g., may operate in any available frequency band within a variety of bandwidths). There are significant indoor penetration advantages that make systems that operate close to a carrier frequency of 1 GHz efficient and cost-effective for a combination of cellular and PNT purposes. One such band is the 1002-1028 MHz band. The cellular PNT network including PRSs could operate, for example, in frequency division duplex (FDD) mode, time division duplex (TDD) mode, or in a downlink-only mode in a carrier aggregation with another FDD or TDD cellular network band.

Another aspect concerns access and availability of the PNT signals in the cellular network for use to a wider set of users (including users of another cellular network) beyond the specific cellular network subscribers. Aiding or assistance information may be provided to, optionally, access-controlled UEs that have any form of data connectivity (e.g. data connectivity of this specific cellular network, WiFi, another cellular network's data connectivity), through a data connection to an assistance server that provides information to facilitate access and usage of the dedicated PNT signals for position/timing application. This application discusses the approach and mechanism for open access to the cellular network positioning signals for PNT services.

Systems and methods disclosed herein are directed to the design, deployment, and operation of a cellular PNT (Cell-PNT) capable network that is operable to provide data services as well as enhanced position, navigation, and timing (PNT) services to UEs, such as mobile devices (e.g., phones, laptop computers, tablets, or other devices). In some embodiments, the Cell-PNT network may utilize 5G NR signals to transmit PRS for position estimation of the UE. In some embodiments, the Cell-PNT network may be a Third Generation Partnership Project (3GPP) NR-based wide area cellular network covering both indoor and outdoor environments. The network could operate in FDD mode, TDD mode, or in a downlink-only mode in a carrier aggregation with another FDD or TDD cellular network.

The Cell-PNT network advantageously provides three dimensional location services and precise timing services within a certain target accuracy relative to UTC, and in some applications, requiring traceability and verifiability relative to UTC. In some embodiments, the Cell-PNT network may be based on a 5G NR design, aligned with 3GPP global standards, thereby enabling and ensuring broad access to global ecosystem partners for chipsets, equipment, and software. The use of 5G NR technology and the incorporation of 5G PRSs provide a foundation for the Cell-PNT network.

However, there are many considerations beyond merely transmitting PRSs as the positioning reference when building an accurate, resilient, and cost-effective Cell-PNT network. A Terrestrial Beacon System (TBS), as disclosed in ATIS contribution ESIF-ESM-2015-0038R001, MBS-ICD, includes a network of dedicated, highly synchronized transmitter beacons that transmit spread spectrum signals. These signals may use a combination of CDMA (e.g., using different Pseudo-Random Noise (PRN) codes when transmissions overlap), TDMA, and frequency-offset multiple access.

The cellular (e.g., 5G NR) PRS transmissions are based on the similar concepts of CDMA, including different PRN sequences for PRS transmission from different network entities to reduce the correlation of the orthogonal frequency-division multiplexing (OFDM) PRS symbol transmissions that occur in the same frequency and time, TDMA (through PRS muting), and frequency-offset multiple access (through the comb patterns used for PRS transmission). In some embodiments, the techniques and algorithms used by the TBS may be incorporated into the Cell-PNT network disclosed herein.

U.S. Pat. No. 9,176,217, issued Nov. 3, 2015, and U.S. Pat. No. 9,291,712, issued Mar. 22, 2016, are both assigned in common with the present application, and both are incorporated by reference as if fully set forth herein. These patents disclose that PRN code selection (CDMA), frequency offset (frequency offset multiple access), and slot (TDMA) are three dimensions used in the cell organization of a terrestrial-based PNT system.

By comparison, in the Cell-PNT network disclosed herein that uses PRSs, the dimensions considered for cell organization are PRS ID (PRN code), PRS pattern (comb pattern/frequency offset), and PRS muting (TDMA). These metrics may be used to design a Cell-PNT network that maximizes the number of ranges available as well as the SINR (signal-to-interference noise ratio) for the ranges available to the receiver in various parts of the network.

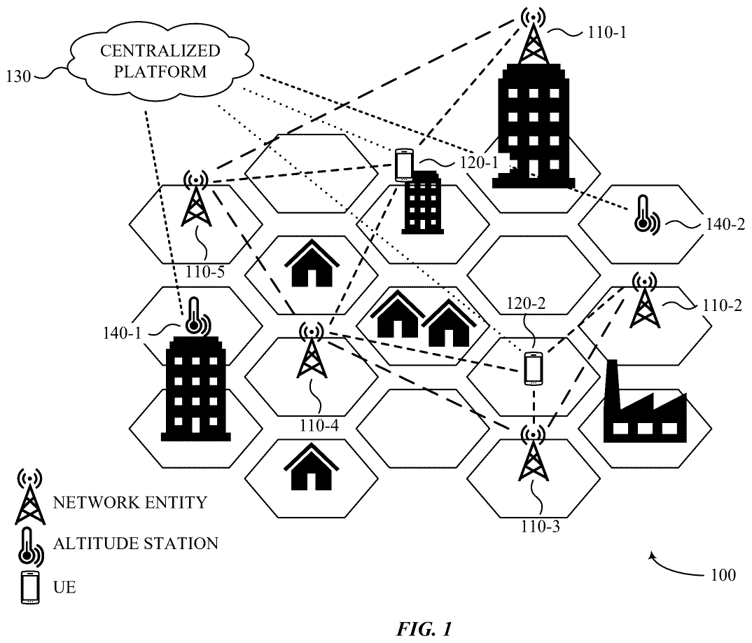

FIG. 1 is an example of a network 100, in accordance with one or more implementations described herein. The network 100 may include a quantity of devices configured to support operations and signaling of the network 100. For example, the network 100 may support a quantity of network entities 110 (e.g., network entity 110-1, network entity 110-2, network entity 110-3, network entity 110-4, network entity 110-5), a quantity of UEs 120 (e.g., UE 120-1, UE 120-2), a centralized platform 130, and a quantity of altitude sensors 140 (e.g., altitude sensor 140-1, altitude sensor 140-2). The network 100 may be an example of a cell-PNT network, such that the network 100 may support providing positioning services to UEs 120 associated with the network 100.

It should be understood that although the objects (e.g., devices, such as network entities 110, UEs 120, altitude sensors 140, buildings, houses) illustrated in FIG. 1 are depicted in given sizes, the objects may be implemented with other various sizes. Likewise, it should be understood that although the objects illustrated in FIG. 1 are depicted in given quantities, the objects may be implemented with other various quantities. It should be understood that the components illustrated in FIG. 1 are exemplary, and networks that include additional components not illustrated and/or include less components fall within the scope of the example illustrated with respect to FIG. 1.

The network entities 110 may be examples of base stations, network nodes, TRPs, or other devices configured to perform operations or communicate signaling associated with the network 100. For example, the network entities 110 may be configured to communicate with the UEs 120 of the network 100. In some examples, the network entities 110 may support communicating with UEs not associated with the network 100, such as UEs registered to a different network (e.g., than the network 100). In some cases, the network entities 110 may be configured to support 5G NR, such that the network entities 110 may perform operations and communicate signaling associated with supporting 5G NR standards. Additionally, or alternatively, the network entities 110 may be configured to perform operations and communicate signaling associated with supporting a cell-PNT network. That is, the network entities 110 may perform operations and communicate signaling to provide positioning services to UEs 120 registered to the network 100. For example, the network entities 110 may be configured to transmit PRSs to the UEs 120 registered to the network 100. In some examples, the network entities 110 may additionally support providing positioning services to UEs 120 associated with a different network than the network 100. That is, the network entities 110 may be configured to transmit PRSs to the UEs 120 registered to the different network.

The UEs 120 may be examples of wireless devices such as mobile phones, tablets, laptop computers, smart devices (e.g., internet of things (IoT) devices), or other devices configured to perform operations or communicate signaling associated with the network 100. For example, the UEs 120 may be configured to support 5G NR, such that the UEs 120 may perform operations and communicate signaling associated with supporting 5G NR standards. Additionally, or alternatively, the UEs 120 may be configured to receive positioning services from the network 100 (e.g., via the network entities 110). Although the UEs 120 are depicted as being included within the network 100, the UEs 120 may be associated with (e.g., registered to) the network 100 or another network. That is, the UEs 120 may be configured to receive positioning services from the network 100 if the UEs 120 are registered to the network 100 or, in some cases, if the UEs 120 are not registered to the network.

The centralized platform 130 may be a server or a computing device configured to communicate with the network 100 (e.g., devices of the network 100, including the network entities 110, the UEs 120, and the altitude sensors 140). For example, the centralized platform 130 may be configured to communicate signaling with the network entities 110 to facilitate providing positioning services to the UEs 120. In some cases, the centralized platform 130 may support configuring the UEs 120 to receive the positioning services from the network 100. That is, the centralized platform 130 may enable UEs 120 to receive signaling from the network 100 (e.g., the network entities 110), despite the UE 120 not being registered to the network 100.

The centralized platform 130 may communicate with the altitude sensors 140 to determine additional positioning information associated with the UEs 120. For example, the centralized platform 130 may receive altitude measurements from the altitude sensors 140, which may be used for comparing with measurements from the UEs 120 to determine positioning information of the UEs 120.

The centralized platform 130 may be configured to support communications beyond the network 100, such as with other networks 100. That is, the centralized platform 130 may facilitate communications for one or more networks including the network 100 to provide positioning services to the UEs 120. In some cases, the centralized platform 130 may communicate with the network 100 to provide network synchronization solutions. In some cases, the network 100 may implement strategies for network synchronization and timing solutions.

Network synchronization may be instrumental for accurately and reliably estimating locations of UEs 120 using Multilateration, as well as for timing. For example, each nanosecond of error in timing may result in an approximately 0.3 m error in position measurements because RF transmission travels at the speed of light (3×10⁸ m/s) and covers approximately 0.3 m in 1 nanosecond. This may result in a range error of approximately 0.3 m and a combination of measurements with Geometric Dilution of Precision or GDOP of 1, leading to approximately 0.3 m of position error.

The network 100 may implement a leader-follower topology as the network architecture, in which one network entity 110 (e.g., node), referred to as the leader (e.g., network entity 110-1), controls some aspect of other network entities 110 (e.g., nodes), referred to as followers (e.g., network entity 110-2, network entity 110-3, network entity 110-4, network entity 110-5). In some embodiments, the network 100 may maintain relative and absolute time synchronization wirelessly using a leader-follower topology of network entities 110 with a UTC-based clock at a leader network entity 110-1. For example, the leader network entity 110-1 may implement a NIST-disciplined Cesium atomic clock that uses the Time and Measurement Service from the NIST or equivalent, other absolute time sources such as time-distribution-over-fiber disciplined clock, or the like, and/or, holdover clocks tied to an absolute source (e.g. Cesium & GPS, Rb & GPS or the like).

Techniques described in co-assigned U.S. Provisional Patent Application, 63/495,367, filed Apr. 11, 2023, all of which is incorporated by reference herein, may be used to design a cost-effective method to distribute traceable time through a leader-follower network. The leader-follower topology (as described in co-assigned U.S. Pat. No. 10,231,201, issued Mar. 12, 2019, and in co-assigned U.S. patent application Ser. No. 18/495,490, which was filed on Oct. 26, 2023, both of which are incorporated by reference herein in their entirety) may be an example of a mesh network that maintains timing synchronization to UTC wirelessly through the listening capability at each network entity 110 of neighboring network entity PRS transmissions that are within range. The coordinates of antennas of the network entities 110 may be determined up to sub-meter accuracy (e.g., more accurate than 50 cm) to enable the use of these coordinates in timing and position trilateration without impacting accuracy. In some cases, some 4G/5G NR cellular systems may only require network entity synchronization on an order of a microsecond. The International Telecommunication Union Telecommunication Standardization Sector (ITU-T) specifies the requirements and architecture for synchronization in packet networks, particularly for frequency synchronization. According to the standard ITU-T G.8271/Y.1366 in Table 1, “Time and Phase Synchronization Aspects of Telecommunication Networks”, a 1.5 us time synchronization requirement for Time Division Duplexing (TDD) is shown.

In some embodiments (as described in the '490 Patent Application and in the '298 Patent Application incorporated above), one or more signal monitoring units (SMUs) may be deployed within a region associated with the network 100 to provide timing corrections associated with in-network and/or out-of-network network entities 110. The SMUs may be co-located at or be part of network entities 110 of the region, and/or located at other positions within the region. Given known coordinates of network entities 110 and SMUs within the region, the SMUs are operable to listen to signals from the network 100 as well as to signals from other networks and to provide a timing correction assistance service for network entities 110 and/or UEs 120 associated with those networks. Such timing assistance data may be provided as timing correction data to other network operators, and/or directly to the UEs 120 via cellular communication signals, or as an over-the-top data transmission. In embodiments where an SMU is co-located with a network entity 110, one or more receive chains of the network entity 110 may be tuned to a frequency of other networks to generate the timing assistance data.

The present embodiments provide scalable and cost-effective time synchronization techniques capable of achieving significantly tighter time synchronization as compared to conventional solutions, potentially by orders of magnitude, implemented into a 5G NR network, thereby enabling a robust and accurate positioning (e.g., PNT) service. In addition, the systems and methods disclosed herein may advantageously transfer time wirelessly in a mesh network of network entities 110 and facilitate precise transmission synchronization of the PRSs by accurately estimating a delay of the positioning signals (PRSs) as they pass through transmitter hardware, cables, and all components up to the phase center of the antenna.

Time synchronization techniques which may be applied to the Cell-PNT network disclosed herein are described in the '201 Patent incorporated above, U.S. Pat. No. 9,967,845, issued May 8, 2018, May 8, 2018, and U.S. patent application Ser. No. 18/631,154, filed Apr. 10, 2024, all of which are assigned in common with the present application incorporated by reference as if fully set forth herein.

In the network 100, the two-way time transfer (TWTT) concept of transferring time by listening to other transmissions when not transmitting may be implemented (as described in co-assigned U.S. Pat. No. 9,057,606, which was issued Jun. 16, 2015, and which is incorporated by reference herein in its entirety, and in the '845 Patent incorporated above). In the network 100, each network entity 110 may listen to other hearable PRS transmissions when its own PRS transmission is muted, and derive time-of-arrival measurements from the PRS transmissions of other network entities 110. Using such timestamped PRS measurements from two network entities 110 that may hear each other, a two-way time transfer measurement between two network entities 110 may be derived. Such a listening capability, for example, may be implemented using a standard network entity 110 architecture by using the digital-pre-distortion PA feedback path that is commonly used in network entities 110 for PA linearization (as described in the '201 Patent incorporated above) or through another available receive chains. In general, TWTT measurements may be derived by listening to PRS transmissions during times of muting (in FDD mode), or, more generally, not transmitting (e.g. in TDD mode), through a receiver chain tuned to transmission frequency.

Once the individual TWTT measurements for various network entity 110 pairs are obtained, they are sent to a TWTT server (as described in the '490 Patent Application incorporated above) to compute the TWTT network synchronization corrections for a network entity 110. The timing correction may either be fed back to the network entities 110 and applied to adjust the transmit timing, or, maintained as timing corrections in a cloud database (e.g., at the centralized platform 130) to be provided as part of PRS assistance data. For example, the PRS assistance data may include a timing correction for each network entity 110 that the UEs 120 may apply to the TOA estimates derived by using the signals from the network entities 110, before using them for position or time estimation.

In the network 100, the network entities 110 may be considered to form the leader-follower topology which may implement the listening capability during PRS muting, thereby allowing PRS transmissions of other network entities 110 to be heard and used to measure the TOA. Once the TOAs of pairs of network entities 110 are available, TWTT measurements may be formed and optimal algorithms may be applied (as described in the '490 Patent Application incorporated above) to obtain timing corrections for each network entity 110.

Establishing timing synchronization involves time synchronization in the transmit chain hardware (as described in the '606 Patent incorporated above) to align the transmit samples to pulse per second (PPS), which may involve fine time estimation using high-speed clocks of the PPS to sample clock error. Similarly, this may include applying a correction to the transmit time or using a time correction for signal measurements from that transmitter.

PRS configurations, including PRS sequences, comb patterns, and muting strategies for various network entities 110 of the network 100, are designed, selected, and utilized to achieve a terrestrial based positioning-enabled network (e.g., a terrestrial PNT network). Such a network may manage PRS interference to enable the reception of sufficiently quality PRSs to achieve targeted positioning quality within the designated coverage area.

In some embodiments (as described in co-assigned U.S. Pat. No. 10,608,695, which was issued Mar. 31, 2020, and which is incorporated by reference herein in its entirety), beacon transmit parameters may be selected. These include PRN sequence, slot, and frequency offset for minimum interference. The selected parameters may enable enhanced positioning performance for UEs 120 in the coverage area. In the network 100, the corresponding dimensions are PRS ID (PRN code), PRS resource element pattern (comb pattern/frequency offset), and PRS muting (TDMA). These network design parameters may be applied to the selection of PRS configurations to enable low interference between PRS transmissions which facilitates better positioning performance. In some embodiments, it may be unnecessary for each network entities 110 to transmit the PRSs to achieve a target positioning performance. For example, a subset of network entities 110 may transmit the PRSs to achieve a target positioning performance. Such a subset may be determined by optimizing the subset selection using metrics (such as GDOP) that affect positioning performance, such as to select parameters to form an optimal PRS network configuration for high-performance PNT.

In some embodiments, UE processing algorithms for accurate ranging measurements and trilateration/timing may be implemented to enhance the accuracy and reliability of the positioning performance. The following documents disclose results based on such techniques: a US-DOT report titled “Complementary PNT and GPS Backup Technologies Demonstration Report;” an EU-JRC Report on “Assessing Alternative Positioning, Navigation and Timing Technologies for Potential Deployment in the EU;”. In addition, the following documents disclose results based on such techniques: a paper presentation at ION ITM 2022 showing positioning and navigation results titled “TerraPoiNT: Terrestrial Navigation System;” and a paper presentation at ION PTTI 2022 showing time transfer techniques titled “A Novel Method to Transfer Time Using the Terrestrial Timing System”. In other embodiments, technology for ranging and trilateration using OFDM reference signals in 4G cellular networks may be used as disclosed in a paper presentation at ION GNSS+2023 titled “Resilient 3D Navigation and Timing System using Terrestrial Beacons and Cellular Signals.” In the context of the network 100, once a channel estimate in the frequency domain is obtained using the PRS, similar techniques to those described in co-assigned U.S. Pat. No. 8,130,141, which issued Mar. 6, 2012, all of which is incorporated herein by reference in its entirety, may be applied to estimate the TOAs using a MUSIC algorithm.

Alternately, techniques using code and Doppler-based TOA estimation (for example, as described in co-assigned U.S. Pat. No. 10,042,037, which issued Aug. 7, 2018, co-assigned U.S. Pat. No. 10,880,678, which issued Dec. 29, 2020, and co-assigned U.S. Provisional Patent Application No. 63/595,1054, which was filed on Nov. 3, 2023, all of which are incorporated by reference herein in their entirety that were developed for cellular reference signals), may be applied to the PRSs to estimate TOAs with good performance and low complexity. In addition, interference cancellation (e.g., as described in co-assigned U.S. Provisional Patent Application No. 63/589,298, which was filed Oct. 10, 2023, all of which is incorporated herein in its entirety), adapted to PRSs to cancel PRSs that overlap in frequency and time with the target PRS may improve SINR (signal to interference plus noise ratio) and enable detection of more PRSs or provide improved TOA performance.

Once TOA measurements are determined, a pseudorange may be formed for each measurement, and, various methods of multilateration or position estimation may be used to estimate the position of a UE 120. For example, a non-linear global L1-norm minimization-based multilateration (as described in co-assigned U.S. Pat. No. 9,720,071, which was issued on Aug. 1, 2017, and co-assigned U.S. Patent Application No. U.S. Ser. No. 17/769,815, filed Apr. 18, 2022, all of which are incorporated herein by reference in their entirety) or piecewise linear loss function weighting of TOA as part of multilateration (as described in the '815 Patent Application incorporated above, and in co-assigned U.S. Provisional Patent Application No. 63/568,554, which was filed on Mar. 22, 2024, and which is incorporated herein by reference in its entirety) may be used to determine an accurate position estimate. In some cases, time estimation may be considered as a subset of position estimation, where time may be obtained as a by-product. Alternately, time may be estimated with known coordinates of the UE 120.

The network 100 may provide a three-dimensional positioning service which, in some embodiments, includes a barometric-sensor-based differential Z-axis solution. Conventionally, terrestrial positioning systems, GPS, and GNSS, may be limited with respect to estimating the height of a UE 120 through trilateration. For example, GPS/GNSS systems may be associated with a limited vertical accuracy relative to horizontal accuracy due to poor Vertical Dilution of Precision (VDOP), since satellites are above the Earth's surface. Terrestrial systems may have a similar limitation with respect to estimating the height of a UE 120 through trilateration, since terrestrial transmitters are positioned essentially on the same plane. While height differences in terrestrial transmitter deployment may help to improve the VDOP, the altitude accuracy may be limited for traditional terrestrial PNT systems. Indoor locations, where accurate UE height information is most relevant and critical, may prove to be challenging environments for some GPS and/or terrestrial systems.

In some embodiments, a sensor-based Z-axis solution that delivers precise “floor-level” vertical positioning is disclosed. This Z-axis solution may be integrated into the network 100 to offer comprehensive and full three-dimensional position solutions.

An accurate Z-axis solution may be obtained, for example, using a calibrated reference network of cost-optimized altitude stations 140 measuring pressure (as described in co-assigned U.S. Pat. No. 10,551,271, which issued on Feb. 4, 2020, and U.S. patent application Ser. No. 18/053,254, filed on Nov. 7, 2022, all of which are incorporated herein by reference), collecting and managing this reference pressure information in the centralized platform 130 (e.g., the cloud), enabling computation of accurate altitude by performing the calibration of the pressure sensor on the device (either on the altitude station 140 or on the centralized platform 130, as described in co-assigned U.S. Pat. No. 10,514,258, which issued on Dec. 24, 2019, U.S. Pat. No. 11,555,699, which issued on Jan. 17, 2023, and U.S. Pat. No. 11,333,567, which issued on May 17, 2022, all of which are incorporated herein by reference in their entirety), determining a reference pressure based on the two-dimensional position (coarse quality if sufficient) of the UE 120, using the reference pressure assistance for that two-dimensional position in combination with the calibrated pressure reading on the altitude station 140 or the UE 120 to determine altitude and/or floor (either at the UE 120 or on the centralized platform 130) of the altitude station 140 or the UE 120 (as described in the '141 Patent and the '606 patent incorporated above, and in co-assigned U.S. Pat. No. 11,215,453, which issued on Jan. 4, 2022, and U.S. patent application Ser. No. 18/322,874, which was filed on May 24, 2023, all of which are incorporated herein by reference in their entirety).

By leveraging two-dimensional positioning data and 5G NR data connectivity of the network 100, the Z-axis solution may be integrated into the network 100, thereby providing a seamless service experience for end-users (as described in the '271 patent, the '254 patent application, the '874 patent application, the '453 patent, and the '258 patent incorporated above, as well as U.S. Pat. No. 11,536,564, which issued on Dec. 27, 2022, all of which is incorporated herein by reference in its entirety).

In some embodiments, the network 100 may allow its positioning service to be accessed by compatible UEs 120. In some embodiments, the UEs 120 may be registered or part of the network 100. In some embodiments, the UEs 120 may not be registered nor part of the network 100. In some embodiments, there may be a combination of some UEs 120 that are registered or part of the network 100, and other UEs 120 that are not registered nor part of the network 100.

In some embodiments, the network 100 may use a downlink (DL) PRS. In some embodiments, the network 100 may implement a duplex TDD/FDD system with PRS in the downlink and Sounding Reference Signals (SRSs) in the uplink (UL). From a positioning perspective, the availability of SRSs enable operation of the cellular (e.g., 5G NR) network 100 without the fine timing synchronization and provide accurate position and navigation using Round-Trip-Timing (RTT) measurements. For example, a PRS TOA may be measured on the downlink at the UE 120, and the SRS TOA may be measured on the uplink at the network entity 110. These measurements may be combined, along with other delay corrections, to form an RTT measurement. The RTT measurement in time, after multiplication by the speed of light, may provide a range measurement between the UE 120 and the network entity 110. Using a minimum of at least two RTT range measurements through PRS and SRS measurement pairs corresponding to multiple UE-network entity pairs, a two-dimensional or three-dimensional position solution may be computed. Alternately, UL-TOA measurements may be obtained using SRS signals at the network entity 110 to determine the two-dimensional position directly, assuming that the network entity 110 is already synchronized.

In another embodiment, one RTT measurement may be combined with PRS TOA measurements and/or with SRS TOA measurements from other network entities 110 to compute a UE position estimate. In all cases, a three-dimensional position (with a more accurate Z-axis) may be computed by the network 100 with a pressure-based solution using, for example, reference pressure derived from a network of reference altitude sensors 140 and a calibration-managed UE pressure sensor measurement.

In one embodiment, a coarse two-dimensional position may first be estimated using TOAs estimated using the PRS and/or SRS signals of the network 100, and then a Z-axis estimate may be found using that coarse two-dimensional estimate (latitude and longitude). The Z-axis estimate may be used along with determining the reference pressure at that location using reference pressure assistance; then, combined with a calibrated device pressure to determine the Z-axis estimate. The Z-axis estimate in combination with the TOAs from PRSs and/or SRSs may be used to determine a finer estimate of the two-dimensional coordinates (latitude and longitude) as part of the final fine three-dimensional estimate.

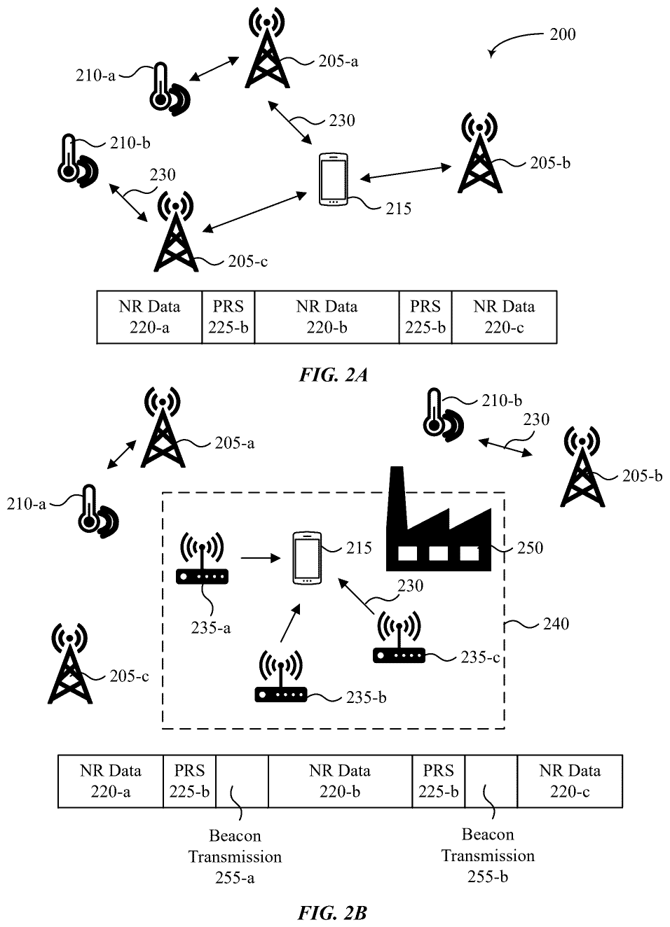

The network 100 shown in FIG. 1 may be a macro-level layer that provides a basic positioning service with key performance indicators (KPIs) targeted for wide areas. Whereas, FIG. 2 may be a schematic of an augmented network 200, in accordance with some embodiments. The augmented network 200 may also support PRS-based beacon-only deployments for providing additional site-specific, value-added PNT accuracy and resiliency. Therefore, the augmented network 200 may integrate coexistence between the macro-layer and underlying beacon-only deployments when available.

There are some positioning and navigation applications such as eVTOL, drones, and self-driving cars where the accuracy/reliability/resiliency of the network 100 and PNT solution required may be quite different from what may be achieved in a standard cellular network. To support such applications within a same frequency band used for the larger network 100 mentioned above, one approach may include setting aside time intervals in the larger network 100 for a dedicated augmentation network 200 meant for positioning signal transmissions and optionally, broadcast data related to PNT. Such an augmentation network 200 may be deployed in target areas (e.g., vertiports or streets) and use these time intervals for transmitting positioning signals (and optional broadcast data). This system design approach, by virtue of the dedicated beacons, de-couples the requirements of such a dedicated network with specific requirements and the larger network 100 and, thus, makes the overall cost more efficient, for example, by relaxing the requirements (e.g. with respect to reliability and resiliency) on the larger network 100.

Macro network entity hardware for cellular (e.g., 5G NR) services with power output greater than a few watts commonly use digital pre-distortion (DPD) RF receive chains that may tap into the transmitter signal at a box output, and feedback that signal for PA linearization algorithms. The PA linearization algorithms may operate on a processor or other hardware platform using I/Q samples from the RF chain. The '201 Patent incorporated above discloses two-way time transfer with a leader/follower topology. This includes listening through DPD linearization to the receive path of the transmitter. This may be applied to listening to PRSs during times of muting (in FDD mode). More generally, while not transmitting (in TDD mode), this may be applied through a receiver chain tuned to transmission frequency (it could re-use a DPD receive RF chain or use a separate RF chain), deriving TOA measurements of other hearable transmitters, and transmitting the TOA measurements to a TWTT server to compute the TWTT network synchronization corrections. The timing correction may either be fed back and applied to adjust and correct the transmit timing, or be maintained as timing correction in a cloud database (e.g., the centralized platform 130) to be provided as part of PRS assistance data to the UE 120 when using the PRS TOAs for positioning estimation purposes.

In some embodiments, the DPD RF receive chains may be used for multiple purposes including for Two-Way Time Transfer (TWTT) and spoofing detection (when not transmitting). During transmission, there may be a small amount of reflection transmit signal from the antenna that may be tapped using a circulator into the receive path along with any directly coupled transmitted signal. By using the TOA estimation of the reflected signal relative to the transmitted signal, the cable and antenna delays may be estimated. U.S. Pat. No. 9,057,606, issued Jun. 16, 2015, is assigned in common with the present application, and is incorporated by reference as if fully set forth herein, discloses timing synchronization in transmitter hardware, and the maintaining and application to either correct the timing of the transmitter or provide the correction through assistance computed at a server (e.g., the centralized platform 130). In some embodiments, TWTT may not rely on the DPD receive path. For example, when the DPD receive path is not available, another available RF receive chain may be set up to tune to the transmit frequency to receive the transmitted signal for use in TWTT/spoofing detection.

In some cases, one or more network entity PRSs may be spoofed by a bad actor in order to produce incorrect positioning estimates for UEs 120 in the area. These spoofed PRSs may have some inconsistencies in their transmissions. These inconsistencies may be detected in the form of PRS parameters (e.g., PRS ID) or based on the inconsistent TOAs from expected PRS IDs at a given location. In some embodiments, the TWTT capability at a network entity 110 with known coordinates, and a list of known coordinates of the network entity 110 from an authentic source (e.g. the centralized platform 130) that are hearable at each given network entity 110, allows for spoofing detection of network entity PRSs. In addition to TWTT capability, a listening capability of the network entity 110 may enable integrity alarms by checking the transmissions from the network entities 110 for various anomalies including timing and content of transmissions. In some cases, idle periods on the DL and/or when there are slots with no DL transmission scheduled by the scheduler (beyond PRS muting durations) may be used to listen to the signals in the environment. For example, synchronization signals such as PSS/SSS/BCH, as well as control channels, may be listened to; and messages such as SIB/MIB may be decoded, for expected neighboring cells, to identify expected inconsistencies in data content by comparing against known data about the network entities 110 available within the network 100.

The network 100 may be configured for greater resiliency (e.g., jam resiliency) at the UEs 120 by using techniques for narrowband jammer detection and removal (as described in co-assigned U.S. Pat. No. 10,281,556, which issued May 7, 2019, and co-assigned U.S. Pat. No. 9,874,624, which issued Jan. 23, 2018, all of which are incorporated by reference herein in their entirety). Such techniques may be implemented in an OFDM system since the FFT of the input signal is already done as part of UE processing. One other technique to mitigate jammers is through a fast AGC that may respond to the dynamics of the jammer.

The network 100 may use cellular (e.g., 5G NR) applications for different applications while considering factors such as integrity, continuity, and availability. One potential approach for enhancing availability and continuity metrics is the improvement of reliability in individual network entities 110 or reliance on network-level redundancy. For example, network level redundancy may be improved by using more than the minimum PRS measurements for positioning during the PRS parameter network design. Most network entities 110 generally have multiple Tx and Rx chains (e.g., transmit and receive chains), and any failures in one or more Tx/Rx chains may be mitigated by using other available chains (e.g., with some loss in quality of service (QOS) due to diversity loss). Multiple sources of timing at the leader network entity 110-1 may also be used to increase resiliency to timing failures from individual sources.

From an integrity perspective, the UE 120 may validate the PRSs and measurements it is using in a positioning solution or timing based on performing Receiver Autonomous Integrity Monitoring (RAIM) on the UE 120, as well as by checking with the network 100. For example, validation may be determined from an integrity server through an encrypted interface to authenticate all the PRS measurements being used in the solution. The integrity server may maintain a list of spoofed signals based on the network entity reports from a listening capability on the network entity 110 and may validate the measurements used by the UE 120, as well as flag the spoofed signals. In some cases, the UE 120 may also receive a list of only authentic PRSs to acquire and use in its positioning solution from an assistance server (e.g., the centralized platform 130). The assistance may itself be received through an encrypted channel available as part of the network 100 natively, or through a secure data plane interface.

In some embodiments, the network entity 110 may be part of a leader-follower topology having listening capability during PRS muting, thereby allowing PRSs of other network entities 110 to be heard and used to measure TOAs. Once the TOAs are available, algorithms may be applied to obtain timing corrections for each network entity 110.

In the cellular (e.g., 5G NR) framework, a resource block, such as a unit resource in the scheduler, occupies a resource space (e.g., slot) in the time and frequency domains (e.g. 180 kHz for 1 ms). As such, the network 100 provides a mechanism, due to the physical resource block (PRB) or PRB level transmit control capability available through the scheduler, to manage interference from the network 100 to other users in the frequency band, if and when required, by controlling the frequency occupancy or time occupancy of the transmissions. This mechanism may provide support that allows other systems to coexist better with the network 100.

In some embodiments, the network 100 may use the PRSs as a source for PNT data. PRSs are defined in the 5G NR specifications and provide a class of physical signals developed for the purpose of positioning and timing measurements. PRSs may include a group of specially designed reference signals, which are broadcasted by 5G (e.g., cellular) network entities 110. These signals are designed to be easily detectable in the presence of other signals, allowing 5G configured UEs 120 to measure and extract location and timing information accurately. By analyzing the timing (which is equivalent to measuring the distance), angle, and strength of the received PRSs, the UE 120 or centralized platform 130 in the network 100 may calculate and extract the UE's location via various algorithms such as multilateration.

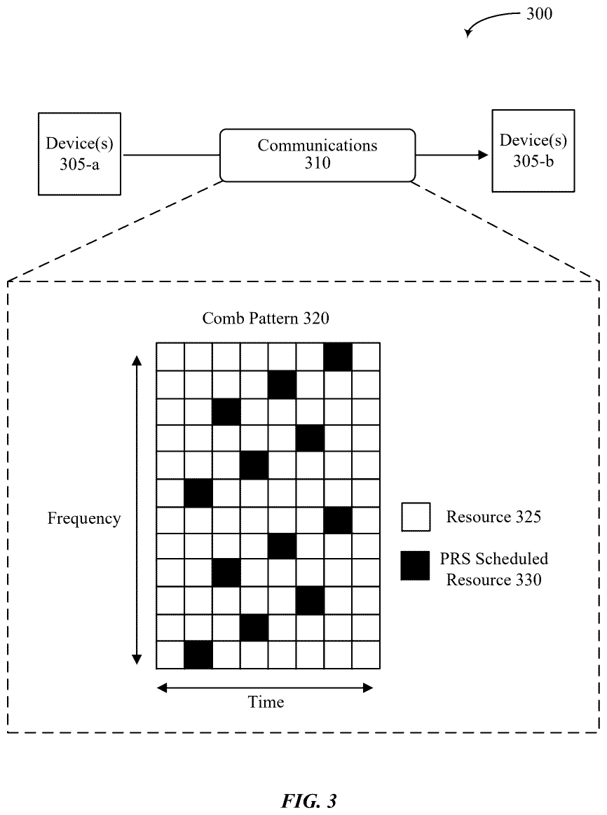

While other reference signals, such as cellular reference signal (CRS) in Long-Term Evolution (LTE), may potentially be used for time-of-arrival (TOA) measurements, the PRS was introduced in LTE to overcome the common near/far interference problem in which very strong reference signals from nearby network entities 110 “drown out” the much weaker signals from network entities 110 farther away. In 5G NR, the PRS configuration may enable UEs 120 to “hear” the weaker reference signals at a higher quality through the use of flexible comb patterns in the frequency domain, to separate transmissions from different network entities 110. An example comb pattern is illustrated in FIG. 3. The flexible comb patterns in the frequency domain may also be used for muting transmissions from network entities 110 according to the muting pattern chosen to reduce the near/far interference.

Techniques related to the network 100 are described in U.S. Pat. No. 9,913,273, which was issued on Mar. 6, 2018, and U.S. Pat. No. 10,470,184, which was issued on Nov. 5, 2019, all of which are incorporated herein by reference in their entirety.

Additionally, U.S. Pat. No. 9,967,845, which was issued on May 8, 2018, is assigned in common with the present application, and is incorporated by reference as if fully set forth herein, discloses two-way time transfer through listening by the transmitter when the transmitter is not transmitting. This may be applied to PRSs with listening capabilities during muting creating a TWTT leader-follower mesh of network entities 110.

FIGS. 2A and 2B are examples of a network 200, in accordance with one or more implementations described herein. FIG. 2A may describe a wide-area PNT network, and FIG. 2B may describe a wide-area PNT network augmented by a beacon-only network. FIGS. 2A and 2B describe communications between multiple devices, including base stations 205, UE 215, altitude sensors 210, and beacons 235. Base stations 205 may be examples of network entities 110, UE 215 may be an example of UE 120, and altitude sensors 210 may be examples of altitude sensors 140 as described with reference to FIG. 2 and FIG. 1, respectively.

FIG. 2A may be an example of a wide-area PNT network. Base station 205-a, base station 205-b, and base station 205-c may communicate with UE 215. For example, one or more of the base stations 205 may transmit and receive communications via connections 230, which may include NR data 220 and PRS 225. For example, base station 205 may transmit NR data 220 and UE 215 may transmit PRS 225. In some examples, base station 205 may communicate PRSs 225. In some examples, transmissions may alternate between NR data 220 (e.g., NR data 220-a, NR data 220-b, NR data 220-c) and PRSs 225 (e.g., PRS 225-b, PRS 225-a). Altitude sensors 210-a and 210-b may communicate data, such as air pressure data, to base stations 205, via connections 230.

FIG. 2B may be an example of a wide-area PNT network augmented by a beacon-only network. FIG. 2B may include beacon network 240, which may include one or more beacons 235 (e.g., beacon 235-a, beacon 235-b, beacon 235-c) communicating with UE 215. In some examples, beacon network 240 may augment the wide-area PNT network, which may improve communications. For example, the signal obstruction and disruption caused by obstacle 250 may be reduced or eliminated. Beacon transmissions 255 (e.g., beacon transmissions 255-a, beacon transmission 255-b) may be received intermittently between NR data 220 and PRS 225.

FIG. 3 is an example of a signaling diagram 300, which may be an example of communications 310 between one or more devices 305 according to comb pattern 320. For example, devices 305 may include base stations, network entities, UEs, beacons, and other devices as described herein. Comb pattern 320 may include a frequency and time domain, in accordance with one or more implementations described herein.

Comb pattern 320 illustrates an example of physical resource blocks (PRB), or resources 325, that may be scheduled in a dedicated PRS slot showing a comb-6 pattern transmission. For example, PRS scheduled resources 330 may be scheduled according to a comb-6 pattern. The comb pattern (e.g., comb-6) repeats every 6 sub-carriers in the frequency domain. Note that this pattern is repeated across the bandwidth, or time domain, of the PRS. Other slots not dedicated to PRS, that is, resources that are not PRS schedules resources 330, may contain data and are not shown in this figure. In the example shown in FIG. 3, one slot=1 ms subframe for 15 kHz carrier spacing. By communicating according to comb pattern 320, communication efficiency may be improved. Techniques described herein may be implemented in accordance with comb pattern 320.

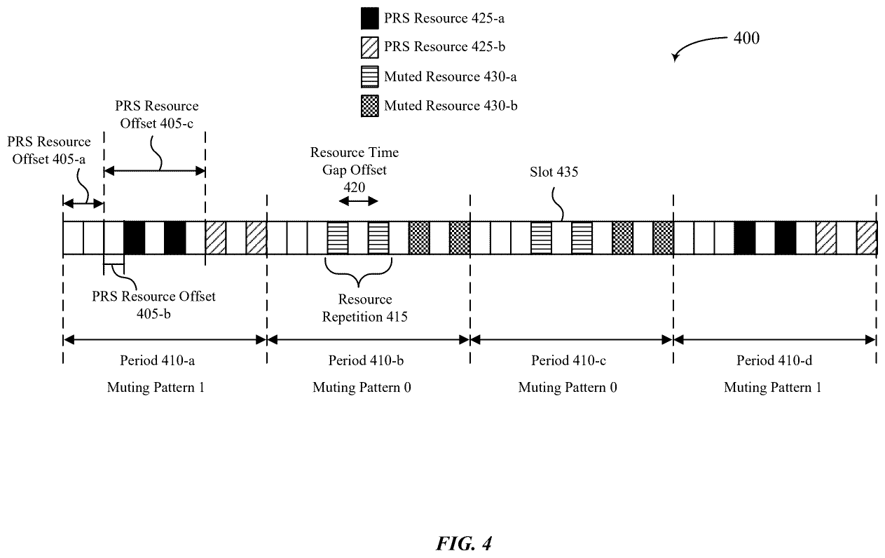

FIG. 4 is an example of a resource timeline 400 that may be an example of a muting pattern, in accordance with one or more implementations described herein. In some examples, FIG. 4 may be implemented by devices described herein, such as network entity 110, UE 115, or other devices. Resource timeline 400 illustrates a series of slots 435. Each slot 435 may have a PRS resource 425, a gap (e.g., resource time gap offset 420), where there is not a PRS resource 425, or a muted resource 430. During a muted resources 430, a PRS resource 425 is muted, and the device monitors for PRSs and refrain from transmitting PRSs. FIG. 4 illustrates a pattern of muted resources 430 and PRS resources 425.

Slot 435 may be repeated one or more times to form a PRS resource instance (that may contain gaps). The PRS resource 425 can be repeated multiple times to form part of a PRS resource set, or resource repetition 415. Some of the repeated instances can be muted to allow for other TRPs (transmit reception points) to transmit without interference between TRPs. For example, resource repetition 415 may include two PRS transmission resources that are muted resources 430 and a resource time gap offset 420 that includes slots 435 between the muted resources 430. TRPs may be an example of device that may implement the techniques described with reference to FIG. 4, as well as other figures describe herein.

Resources may be divided into periods 410 (e.g., period 410-a, period 410-b, period 410-c, period 410d) of a specified number of slots 435. Each slot 435 may represent a portion of time during which resources may be scheduled. For example, PRS resources 425 may be scheduled for transmitting PRSs. In some examples, a muted resource 430 may be scheduled in place of PRS resource 425. That is, resources may not be scheduled, and the slot may be a muted resource 430 where a device refrains from transmitting, and instead monitors for transmissions (e.g., PRSs) from other devices.

PRS resources 425 and muted resource 430 may be scheduled in a pattern, which may be referred to as a muting pattern. Muting patterns may be defined by a bit value, such as muting pattern 0 or muting pattern 1. For example, muting pattern 1 may be associated with period 410-a and 410-d, and muting pattern 0 may be associated with period 410-b and period 410-c. As described with reference to FIG. 4, muting pattern 1 may include patterns of PRS resources 425, and muting pattern 0 may include patterns of muted resource 430. Muting patterns may include PRS resource offsets 405, resource repetitions 415, and resource time gap offset 420.

For example, muting patterns may include PRS resource offsets 405, which may define the time, or slots 435, prior to beginning a PRS resource 425 pattern. For example, as described with reference to FIG. 4, each period 410 may include 10 slots 435. In some examples, PRS resources 425 may not be scheduled during the first slot 435 of period 410. The difference between the first slot 435 and the first PRS resource 425 (e.g., either PRS resource 425-a or PRS resource 425-b) may be referred to as a PRS resource offset 405-a. For example, at period 410-a, PRS resource offset 405-a indicates a difference of 2 slots 435 from the beginning of period 410-a.

Further PRS resource offsets 405 may define when different resource patterns begin. For example, muting pattern 1 may include PRS resource offset 405-b and PRS resource offset 405-c. PRS resource offset 405-b may indicate a one slot 435 distance between the PRS resource offset 405-a and the start of a pattern of PRS resource 425-a. PRS resource offset 405-c may indicate a five slot 435 distance between the PRS resource offset 405-a and the start of a pattern of PRS resource 425-b.

Muting patterns may include resource time gap offsets 420 and resource repetitions 415. For example, resource repetitions 415 may define multiple instances of a PRS resource 425 or muted resource 430. For example, there may be two instances of a PRS resource 425. Resource time gap offset 420 may define the slots between resource repetitions 415. For example, there may be a single slot 435 between each PRS resource 425, or muted resource 430.

Muting patterns of PRS resources 425 and muted resource 430 may allow for scheduling of PRS transmissions and scheduling of monitoring for PRS transmissions. For example, a device may transmit PRS signals during period 410-a according to muting pattern 1, and may monitor for PRS signals during period 410-b according to muting pattern 0. By periodically transmissions PRS signals and monitoring for PRs signals, devices may determine timing information and timing corrections, resulting in increased accuracy.

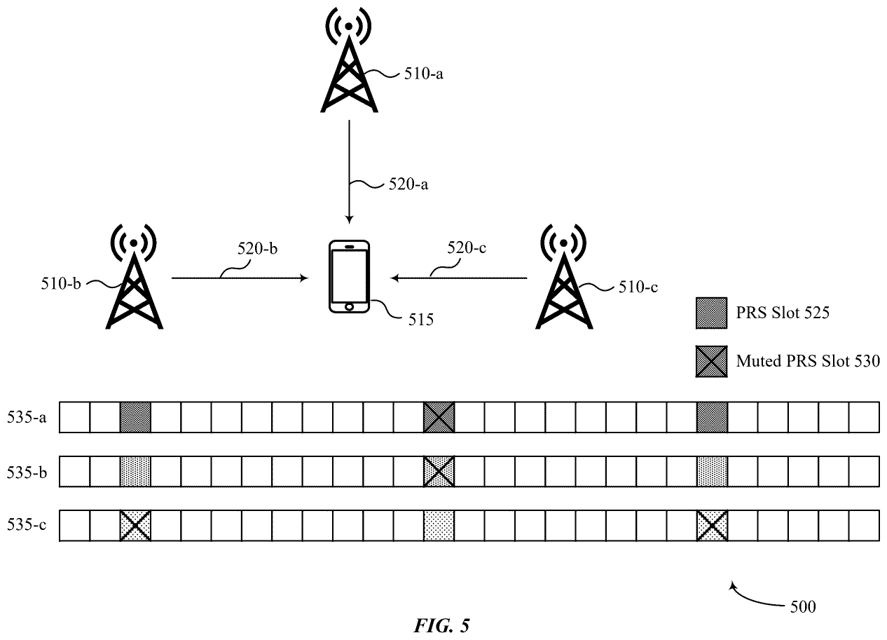

FIG. 5 is an example of a signaling diagram 500, which may be an example of one or more implementations as described herein. Signaling diagram 500 may describe communications between base stations 510 and UE 515. Base stations 510 (e.g., base station 510-a, base station 510-b, and base station 510-c) may be examples of network entities 110, and UE 515 may be an example of UE 120 as described herein with respect to FIGS. 5 and 1, respectively. Base station 510-a may communicate with UE 515 via connection 520-a, base station 510-b may communicate with UE 515 via connection 520-b, and base station 510-c may communicate with UE 515 via connection 520-c. Connection 520 may be a downlink channel. In some examples, base station 510 may transmit one or more PRSs during PRS slot 525 to UE 515 via connection 520.

PRSs may be communicated according to of PRS configuration parameters, in accordance with some embodiments. The schematic, or signaling diagram 500, illustrates an example of various PRS configuration parameters such as resources, repetition, and muting. PRS on the downlink was first introduced in 3GPP release 9 in the LTE standard to provide dedicated reference signals for positioning use cases. Release 16 5G NR introduced PRSs with greater flexibility and parameter configuration to enable better accuracy and reduced interference (technical specification 3GPP TS 38.211). In order to improve PRS receptibility, these PRSs are transmitted during dedicated positioning subframes within the NR transmission, during which other signals are not transmitted, and therefore, limiting collisions with non-PRSs.

Position computation involves time of arrival (TOA) measurements of PRSs from multiple base stations 510 at the UE 515 and combining them using a computation method (e.g., multilateration) to estimate position. The position computation may be done at the UE 515 or at the location server in the core network (e.g., the Enhanced Serving Mobile Location Centre or Location Management Function; technical specification 3GPP TS 38.305) by knowing the coordinates of each base station 510 and the time synchronization among their transmissions. Similarly, timing at the UE 515 that is traceable to the timing of the base station 510 network may be determined from the PRSs using the TOA along with the coordinates of the associated base station 510.

The Cell-PNT network disclosed herein may use PRSs within the 3GPP NR framework. This allows the Cell-PNT network to use the 3GPP standardized 5G NR ecosystem of base stations and UEs, thus, leading to a cost-effective solution. UE receivers in the Cell-PNT network may use standard PRS algorithms or advanced algorithms for ranging and trilateration for further improved PNT performance. For example, standard 5G NR chipsets may be configured via software to support PRS measurement signal processing capabilities that may be used to estimate position. For the 5G NR base stations ecosystem, the 3GPP specifications allow flexible and dynamic allocations of PRSs within the network resources so that PRS deployments may be optimized for various positioning requirements. The base station 510 may configure and schedule PRS transmissions, which may include various parameters, including PRS periodicity, repetition, and bandwidth, etc.

In some embodiments, signal penetration indoors may be obtained through PRS/SRS switched beams available in 5G NR for improved link budge. Beam switching may add additional duration when PRS is transmitted when used in combination with muting, which may be a drawback when used for the dual purpose of data and positioning. Some of the overhead may be overcome by coordinating the transmission of beams from surrounding base stations in such a manner that the beams from nearby base stations avoid pointing in the same direction. In some embodiments, PRS boosting is used, where the resource elements in the comb transmit pattern are transmitted with higher power while the overall power from the symbol remains the same, to improve the PRS link budget, while still keeping the power of the symbol within the PA limits. In some cases, the PRS boosting at the edges of the band may be controlled, if required, to meet an emission mask.

The '490 Patent Application incorporated above discloses a method for optimal two-way time transfer which may be implemented in the Cell-PNT network disclosed herein. The two-way time transfer technique is performed in the context of a mesh network having leader and follower nodes that have listen capability of the signals from other nodes, and may thereafter measure the time of arrival of those other nodes timestamped with the local clock when they are not transmitting. The timestamped TOAs are sent to a two-way time transfer (TWTT) server that determines the optimal timing correction per beacon and, optionally, sends back control to the beacon to adjust timing. In some examples, beacons may be base stations 510.

U.S. Pat. No. 10,608,695, issued Mar. 31, 2020, is assigned in common with the present application, and is incorporated by reference as if fully set forth herein, discloses a network design including GDOP metric, which may select a network design for good PNT performance and which may be implemented in the Cell-PNT network disclosed herein. A subset of base stations 510 transmitting PRSs constitute a network for PNT purposes. The GDOP of the PRS subset network would be designed to provide good-quality positioning within the coverage area. In some examples, base stations 510 may transmit PRSs according to various patterns 535 (e.g., pattern 535-a, pattern 535-b, pattern 535-c). Patterns 535 may include patterns of PRS slots 525 during which PRSs are transmitted and muted PRS slots 530, during which base station 510 refrains from transmitting PRSs. In some examples, base station 510 may receive PRSs during muted PRS slots 530.

In some examples, different patterns 535 may be associated with different base stations 510. For example, pattern 535-a may be associated with base station 510-a, pattern 535-b may be associated with base station 510-b, and pattern 535-c may be associated with base station 510-c. For example, base station 510-a and base station 510-b may transmit during PRS slot 525, during which base station 501-c refrains from transmitting during muted PRS slot 530, and vice versa. By varying the times each base station 510 is transmitting PRSs, collisions are reduced and signal reliability is improved.

### Multipath Mitigation, Interference Cancellation and Multilateration in a Cellular Network Supporting Accurate and Resilient PNT Services

As mentioned above, in some embodiments, UE receiver processing algorithms for accurate ranging measurements and trilateration/timing may be used to enhance the accuracy and reliability of PNT performance. In other embodiments, techniques for ranging and trilateration using OFDM reference signals in 4G cellular networks may be used. In the context of the Cell-PNT system, once a channel estimate in the frequency domain is obtained using the PRS signal, similar techniques to those described in the '141 Patent incorporated above may be applied to estimate the TOAs using the MUSIC algorithm. Alternately, techniques using code and Doppler-based TOA estimation described above may be applied to the PRS signals to estimate TOAs with good performance and low complexity. In addition, interference cancellation described above and adapted to PRS signals to cancel PRS signals that overlap in frequency and time with the target PRS signal may be used to improve SINR (signal to interference plus noise ratio) to detect relatively more PRS signals and/or improve TOA performance.

In a position and/or navigation application, once TOA measurements are determined from the PRS signals, a pseudorange may, optionally, be formed per measurement and, a position computation method, such as using a non-linear global L1-norm minimization-based multilateration or piecewise linear loss function weighting of TOA as part of multilateration, may be used in combination with the coordinates of the antennas transmitting the PRS signals, to determine a good position estimate. In addition, a position estimate, if already available, in a position filter (such as an Extended Kalman Filter or Particle filter) may be updated using these TOAs or pseudoranges.

In a timing application, similarly, once TOA measurements corresponding to the PRS transmissions are determined, the time estimate of a Cell-PNT slot/frame boundary may be determined using the coordinates of the antennas transmitting the PRS signals and the coordinates of the timing receiver, if known. If the coordinates of the timing receiver are unknown, then the coordinates of the timing receiver may be determined as part of the solution along with the time estimate. In order to determine the PPS time and the corresponding UTC timestamp, additional system information may be required to be decoded or provided as assistance. For example, the sub-frame number (SFN) and a mapping of the SFN to UTC time in the Cell-PNT system may be extracted from System Information (SI) messages.

Techniques that are the same as, or similar to, those disclosed within co-assigned U.S. Pat. No. 10,042,037 B2, issued Aug. 7, 2018, U.S. Pat. No. 10,880,678 B1, issued Dec. 29, 2020, U.S. Provisional Patent Application No. 63/595,954, filed Nov. 3, 2023, and U.S. Provisional Patent Application No. 63/589,298, filed Oct. 10, 2023, all of which are incorporated herein by reference in their entirety, may be advantageously employed within the context of the Cell-PNT network disclosed herein.

In some embodiments, spectrum shaping and maximum likelihood detection of the earliest path may be used by the hybrid network disclosed herein. These may be code-based techniques for multipath mitigation that do not use any movement of the UE. In some embodiments, such techniques are combined with Doppler (filtering), similar to the process described in co-assigned U.S. Provisional Patent Application No. 63/595,954 filed Nov. 3, 2023, all of which is incorporated by reference herein, to further facilitate the extraction of the earliest path when there is movement of a UE.

The same or similar techniques are readily applicable to positioning signals provided by the Cell-PNT network disclosed herein (e.g., which may use 5G PRS signals). Such techniques may achieve performance levels that meet or exceed the performance of conventional super-resolution algorithms, and in some scenarios, may perform better than conventional super-resolution algorithms at low SNR, and with very low complexity relative to super-resolution algorithms.

For example, an enhancement over MUSIC is described in the '954 patent application to handle coherent and non-coherent accumulation.

### Specifics of 5G PRS (Positioning Reference Signal)

As an example of UE PNT services provided using a hybrid network as disclosed herein, 5G PRS signals may be transmitted per slot of variable duration (e.g., 1 ms, 0.5 ms, 0.25 ms, 0.125 ms . . . ) depending on the 5G numbering scheme. For the purpose of simplicity, the description herein considers a 1 ms slot with 15 kHz subcarrier spacing (e.g., for simplicity) which may be extrapolated to other numerologies (e.g., with double, quadruple, or other subcarrier spacing).

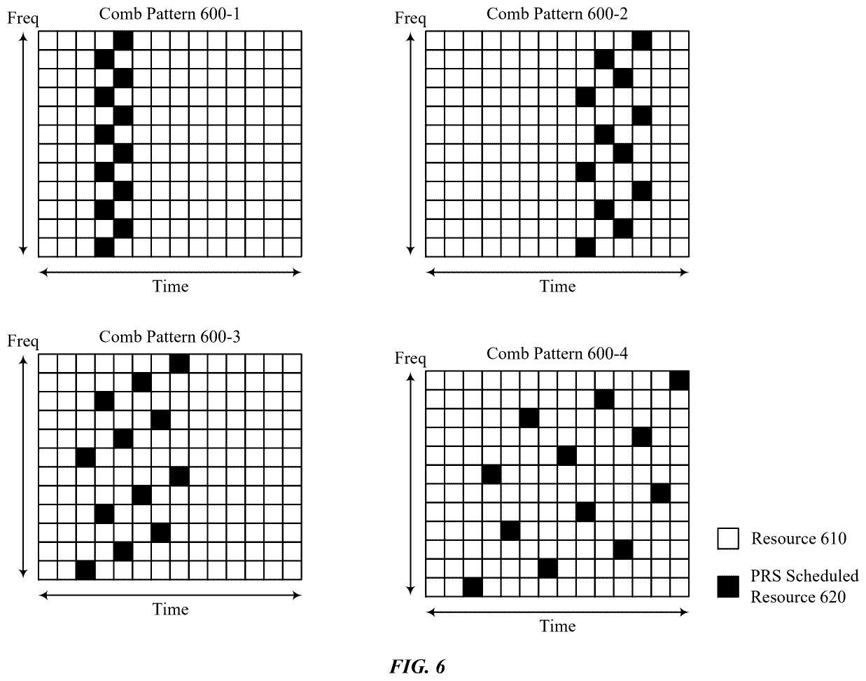

FIG. 6 illustrates example comb patterns 600 (e.g., comb pattern 600-1, comb pattern 600-2, comb pattern 600-3, comb pattern 600-4) in accordance with examples as described herein. Comb patterns 600 may be various implementations of comb pattern 320 as described with reference to FIG. 3. For example, comb patterns 600 may illustrate resources for facilitating communications (PRSs) between different devices (base stations, network entities, UEs, beacons, centralized platforms), such as for communications 310 between devices 305.

Comb patterns 600 are illustrated with reference to an axis representing a frequency domain (e.g., a y-axis, a vertical axis) and an axis representing a time domain (e.g., an x-axis, a horizontal axis). That is, comb patterns 600 each illustrate a quantity of frequency resources (e.g., carriers, subcarriers) in the frequency domain and a quantity of symbols (e.g., OFDM symbols) in the time domain. For example, comb pattern 600 each illustrate a resource block in the frequency domain including 12 carriers (e.g., subcarriers), and a slot in the time domain including 14 OFDM symbols. Additionally, comb patterns 600 illustrate distinctions between resources 620 (e.g., PRS scheduled resources 620) reserved for communicating one or more PRSs, and resources 610 reserved for other signaling (e.g., not illustrated in FIG. 6) or reserved for not performing communications.

Comb patterns 600 also illustrate how certain subcarriers per slot per RB (Resource Block of 1 OFDM symbol and 12 subcarriers) may be used by the PRSs transmitted from a given cell or TRP (Transmit Reception Point), or from a given beam of the cell or TRP, in accordance with some embodiments. Different patterns are shown with comb 2, 4, 6, and 12 (i.e., spacing between PRS subcarriers per RB). For example, comb pattern 600-1 illustrates a comb-2 pattern, with resources reserved for PRS in a repeated pattern across all carriers of the RB spanning two OFDM symbols. Comb pattern 600-2 illustrates a comb-4 pattern, with resources reserved for PRS in a repeated pattern across all carriers of the RB spanning four OFDM symbols. Comb pattern 600-3 illustrates a comb-6 pattern, with resources reserved for PRS in a repeated pattern across all carriers of the RB spanning 6 OFDM symbols. Comb pattern 600-4 illustrates a comb-12 pattern with resources reserved for PRS in a repeated pattern across all carriers of the RB spanning 12 OFDM symbols. To simplify the description provided herein, the comb-6 pattern is primarily considered, but it should be understood that the processes described herein readily apply to other comb patterns.

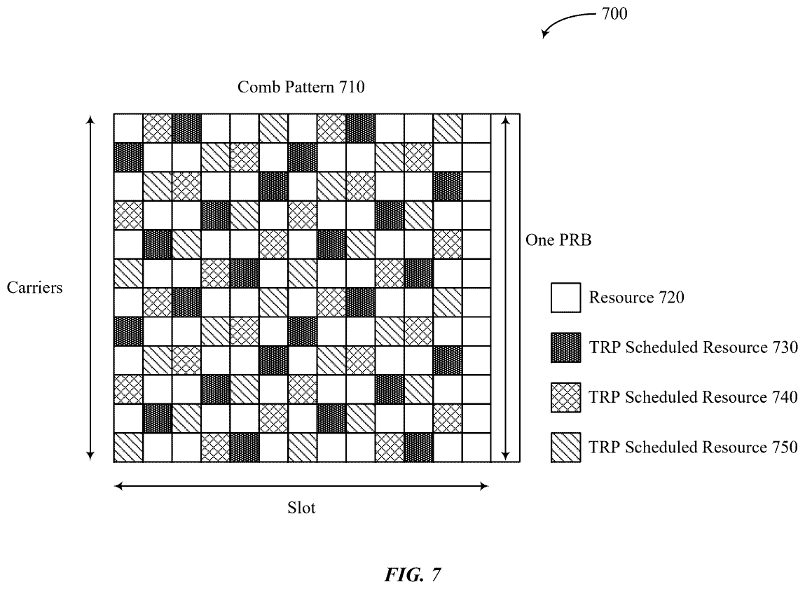

FIG. 7 illustrates an example signaling structure 700 in which different TRPs may implement different comb patterns within a same slot and across the same carriers. For example, signaling structure 700 illustrates three TRPs implementing different resources for communicating PRSs within a same slot and across the same carriers. Furthermore, as shown in FIG. 7, different cells or different beams may occupy other subcarrier offsets, using the same pattern and same comb, in accordance with some embodiments.

For example, signaling structure 700 illustrates a comb pattern 710 implementing resources which may be used by three different TRPs for communicating PRSs. Comb pattern 710 includes each TRP implementing a comb-6 pattern within the same slot and across the same carriers, in which each comb-6 pattern is offset from one another. That is, the comb pattern 710 illustrates resources 720, which may be examples of resources 610, and may or may not include other signaling. Comb pattern 710 also illustrates resources 730, resources 740, and resources 750 which may each be reserved by respective TRPs for communicating downlink PRSs. For example, a first TRP may transmit one or more PRSs via resources 730, a second TRP may transmit one or more PRSs via resources 740, and a third TRP may transmit one or more PRSs via resources 750.

By using different subcarrier offsets, the PRSs of the different TRPs may be approximately orthogonal. In FIG. 7, the comb-6 pattern is repeated twice per slot for each TRP. In some cases, other TRPs may reuse the same subcarrier offset, such that their respective PRS may be transmitted via the same resources as another TRP. In some cases, TRPs may overlay resources, such that the PRSs may be approximately orthogonal based on the overlay of the resources communicating the PRSs.

In some implementations, a slot may be repeated one or more times to form a PRS resource instance (e.g., including gaps). In some instances, a PRS resource can be repeated multiple times to form part of a PRS resource set. As shown in FIG. 4, some of the repeated instances can be muted to allow for other TRPs to transmit without interference between TRPs.

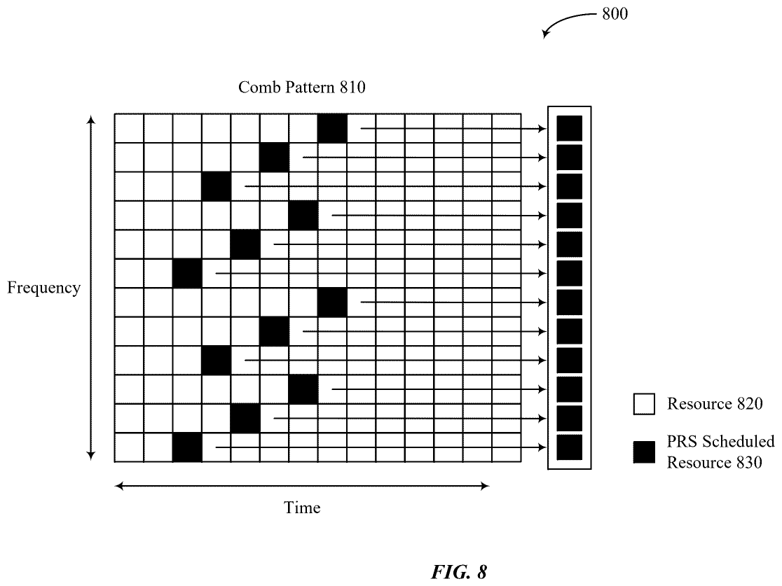

FIG. 8 illustrates an example signaling construction 800 in accordance with one or more implementations as described herein. Signaling construction 800 illustrates a comb pattern 810, which may be an example of a comb-6 pattern such as comb pattern 600-3, as described with reference to FIG. 6. Comb pattern 810 include resources 820 which may be examples of resources 610 or resources 720, and resources 830 which may be examples of resources 620 or resources 730, 740, or 750, as described with reference to FIGS. 6 and 7. Signaling construction 800 illustrates an example process for combining resources across OFDM symbols to form an OFDM symbol with resources from each carrier.

For example, a UE may receive one or more PRSs (e.g., or a portion of a PRS) via resources of a slot from a TRP. The resources may be associated with comb pattern 810, such that the resources may be implemented in a comb-6 pattern with the resources being repeated in a pattern across 6 OFDM symbols. Then, the UE may apply a fast Fourier transform (FFT) for each OFDM symbol of the slot. The UE may extract the carriers of the OFDM symbols as a result of applying the FFT. For example, the UE may extract the PRS subcarriers of the OFDM symbols and descramble the OFDM symbols. After descrambling the OFDM symbols, the UE may merge the OFDM symbols into a single OFDM symbol. In some cases, merging the OFDM symbols may include compacting the time between the OFDM symbols of the slot to form a compacted OFDM symbol. Compacting the time associated with the OFDM symbols to form a compacted OFDM symbol may cause all the PRS subcarriers associated with the OFDM symbols to be associated with the compacted OFDM symbol. For example, the compacted OFDM symbol may include each PRS subcarrier associated with the one or more PRSs transmitted from the TRP in the slot. That is, by merging the 6 OFDM symbols associated with the comb-6 pattern of comb pattern 810, the UE may determine the compacted OFDM symbol with all subcarriers associated communicating the one or more PRSs. In some examples, after generating the compacted OFDM symbol, the UE may perform a multipath mitigation operation using the compacted OFDM symbol.

In some cases, the UE may be a signal monitoring unit (SMU) with known position and time to provide timing corrections. Thus, the operations illustrated in FIG. 8 may be triggered multiple times to listen to as many positioning signals as possible. In some such cases, some of the operations described with reference to FIG. 8 may not be successful for relatively weak and/or interfered signals that overlap in frequency and time with other signals (e.g., due to imperfect network planning, muting pattern, etc.), thus interference cancellation may be applied to recover those unsuccessful operations.

In some cases, compacting the OFDM symbols for a slot (e.g., per slot or per several adjacent slots) may be acceptable without losses, provided that a clock frequency offset (CFO) of the UE is corrected. Likewise, determining the compacted OFDM symbol may be acceptable without losses provided that a speed or Doppler experienced by the UE can be neglected relative to the duration of the slot (e.g., or the duration of several adjacent slots). For example, if the comb-6 pattern to be compacted has a duration of 1 ms, then a maximum Doppler may be less than 100 Hz (e.g., 1 kHz/10, where 1 kHz is 1 over 1 ms). In some cases, the maximum Doppler may be less than 200 Hz (e.g., 1 kHz/5) may also be acceptable. In some embodiments, if the compacted duration is 0.5 ms, then the maximum Doppler may be less than 200 Hz (400 Hz may also be acceptable).

An explanation of the division by 10 and 5 is further explained herein. A frequency error or uncorrected Doppler of 1 kHz may result in a signal performing a full circle rotation within a time period (e.g., 1 ms). That is, a correlation may be fully canceled if Doppler is uncorrected. When the signal is compacted as discussed above, the Doppler may not be corrected because a per-path Doppler value is not known, and multiple paths may have different Doppler values. Thus, such situations may involve uncorrected Doppler. In some cases, if the uncorrected Doppler is 1 kHz/10, then the signal may rotate by 1/10 of a circle within 1 ms. In some such cases, the correlation may not cancel and may be only slightly degraded. The general formula may follow a correlation amplitude loss of sinc ( 1/10) or sinc (⅕) (e.g., power loss is the square of this quantity). For sinc ( 1/10), the loss may be 0.14 dB, and for sinc (⅕), the loss may be 0.58 dB. In some such examples, the values of 0.14 dB and 0.58 dB may be acceptable losses for the correlation output. In some implementations, this may be related to the channel coherence time.

In some embodiments, the UE may convert these Doppler values to vehicle speed as provided. For example, for a 923 MHz carrier frequency, the speed corresponding to a maximum Doppler of 100 Hz may be 120 km/h (e.g., obtained via the formula: (100/carrier_frequency (Hz))*speed_of_light (m/s)*3.6 km/h). This covers speeds in urban environments and therefore compacting over 1 ms may be acceptable. If the compacting duration is 0.5 ms, the maximum speed can be 240 km/h for non-urban environments (e.g., 480 km/h may also be acceptable).

Determining the compacted OFDM symbol as described herein may enable the UE to advantageously perform code-based multipath mitigation. For example, the UE may perform code-based multipath mitigation using a TOA-MF filter to shape the frequency domain, thereby shaping the time domain's impulse response (e.g., as described in the '037 and '678 patents incorporated above). Such filtering may facilitate identifying the earliest path by reducing interference from the late path onto the earliest path.

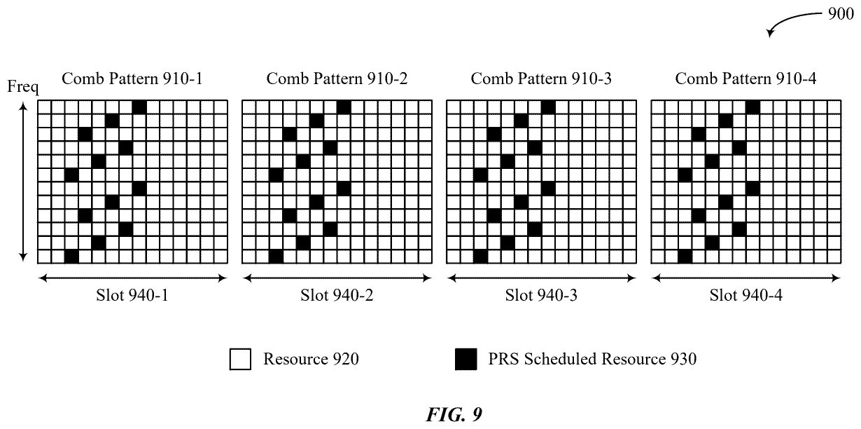

FIG. 9 illustrates an example signaling sequence 900 in accordance with one or more implementations as described herein. For example, signaling sequence 900 illustrates comb patterns 910 (e.g., comb pattern 910-1, comb pattern 910-2, comb pattern 910-3, comb pattern 910-4). FIG. 9 is an extension of FIG. 8, in which more than one slot may be used for transmission consecutively (e.g., or with minor gaps). That is, signaling sequence 900 illustrates transmitting one or more PRSs via the comb patterns 910 consecutively, such as transmitting via comb pattern 910-1, comb pattern 910-2, comb pattern 910-3, then comb pattern 910-4. In some cases, the comb patterns 910 may be separated by one or more OFDM symbols. Each comb pattern 910 is associated with a respective slot 940 (e.g., comb pattern 910-1 is associated with slot 940-1, comb pattern 910-2 is associated with slot 940-2, comb pattern 910-3 is associated with slot 940-3, comb pattern 910-4 is associated with slot 940-4).

Signaling sequence 900 may implemented in various conditions or situations. For example, signaling sequence 900 may be used when a vehicle is moving and various received paths (e.g., from the multipath of one TRP) exhibit different Doppler. By testing for each Doppler hypothesis, the UE may advantageously reduce the impact of other paths having a sufficiently different Doppler. This is in line with the '954 provisional patent application which discloses techniques for how code and Doppler-based mitigation of multipath is performed. Each of the 4 slots above is compacted into one OFDM symbol. That is, comb pattern 910-1, comb pattern 910-2, comb pattern 910-3, and comb pattern 910-4 are compacted into 4 compacted OFDM symbols, similarly to described in FIG. 8 for comb pattern 810.

For example, for each comb pattern 910, a UE may apply a FFT for each OFDM symbol of the slot associated with the respective comb pattern 910. Then, the UE may extract the carriers of the OFDM symbols of the respective comb pattern 910 as a result of applying the FFT and descramble the OFDM symbols. After descrambling the OFDM symbols, the UE may merge the OFDM symbols into a compacted OFDM symbol associated with the respective comb pattern 910. In some examples, the delta time between each of the resulting 4 compacted OFDM symbols may be 1 slot (e.g., 1 ms, and extend over a 4 ms period). In dynamic scenarios, more slots with gaps in between may be provided, extending over a relatively longer duration (e.g., 32 ms). In some such scenarios, this may enable distinguishing between paths separated by more than 20 Hz in Doppler (e.g., more than 1/0.032/2). By testing Doppler hypotheses with a step value (e.g., 20 Hz), some paths may be automatically canceled, enabling improved identification of the earliest path. Some additional details may be disclosed with reference to the '954 provisional patent application incorporated above.

### OFDM Symbol Alignment

In OFDM, the receiver at the UE may be aligned with a received OFDM symbol. Aligning the receiver with the received OFDM symbol may be performed based on listening to a strongest cell's signal synchronization block (SSB) (e.g., including PSS, SSS, and PBCH), which may provide a Super Frame Number (SFN). However, by aligning with the strongest cell, OFDM symbols received from other cells may not be aligned with the receiver based on different signal times of flight. One solution may be to blindly implement one or more different OFDM symbol alignments for the other cells from which the respective SSB may not be detected. Another solution may be to assume that in urban environments the other cells will be aligned roughly within the Cyclic Prefix duration.

An alternative solution is further described in the '298 provisional patent application incorporated above, in which a double-size FFT may be used by the receiver. In this solution, the receiver's FFT window may be aligned to start incrementally before (e.g., ¼ of a symbol earlier) the strongest cell's signal and extend over more than 1 OFDM symbol (e.g., 2 OFDM symbols). In some examples, the FFT window may be at least partially occupied with the received signal (e.g., of 2 OFDM symbols). In some such examples, it may be correlated with the local replica of the transmitted PRS signal that is zero-padded to occupy 2 OFDM symbols (1 normal PRS symbol and 1 more all-zeros symbol).

In some cases, the correlation may be performed in a frequency domain by multiplying with a complex conjugate of the FFT of the zero-padded PRS signal (e.g., the subcarrier spacing may be halved, such as from 15 kHz to 7.5 kHz). In some such cases, the OFDM symbols from all the cells may fit within the FFT window (provided the distances to the cells, or delta distances, are below 20 km). When advancing to a next OFDM symbol, the window may be advanced by 1 symbol (e.g., plus cyclic prefix, not by 2 symbols). Thus, there may exist an overlap between the FFT windows as the OFDM symbols are stepped through (e.g., the FFT covers two symbols and the step size may be 1 symbol).

### Successive Interference Cancellation (SIC)

As described in the '298 provisional patent application incorporated above, SIC can be applied to improve the hear-ability of far away cells. For example, the far away cells may be victims of interference from a nearby cell using similar time and frequency resources. Some situations may operate under different conditions, such as the capture duration being relatively short (e.g., 16 ms instead of 7 seconds), and a mobile device moving.

Addressing such situations may involve multiple solutions. For example, a first strategy may implement short segments (e.g., 1 ms or 2 ms) during which Doppler does not significantly alter the channel (e.g., based on channel coherence time). In some such examples, a channel associated with a strong cell may be next estimated per segment (e.g., of 1 ms or 2 ms). Then, the channel associated with the strong cell may be subtracted per segment (e.g., of 1 ms or 2 ms). After performing this subtraction for one or more strong cells in this manner, relatively weaker cells may become hearable.

In another example, a second strategy may implement longer segments (e.g., 16 ms or 32 ms). In some such examples, the channel may be estimated per Doppler hypothesis, with a Doppler step that is a function of the duration (e.g., 1/16 ms is 62.5 Hz, and the step may be 62.5/4 Hz to be finer than typical steps of 62.5/2 or such in GPS). For a Doppler hypothesis exhibiting the most energy, corresponding paths may be subtracted and then corrected using the Doppler hypothesis. This process may be repeated by subtracting multipath with various Doppler hypotheses and multipath from different cells until the interference from the one or more strong cells is reduced. After performing this process (e.g., including one or more repetitions), the relatively weaker cells may become hearable.

### Loss Function Determination and TOT-Based Positioning

Co-assigned U.S. patent application Ser. No. 17/769,815 filed Apr. 18, 2022, and U.S. Provisional Patent Application No. 63/568,554 filed Mar. 22, 2024, all of which are incorporated herein by reference in their entirety, may be advantageously employed within the context of the hybrid network.

The '815 and '554 applications disclose improvements upon LTE/5G reference signal time difference (RSTD) and location positioning protocol (LPP) by proposing time-of-transmission (TOT) in place of TDOA multilateration. Additionally, TOT L1 and TOT CSI L1 (e.g., for instances in which an initial guess is far away) are disclosed therein. The same or similar improvements may be implemented in the context of the hybrid network disclosed herein.

The piecewise linear loss functions disclosed in the '815 and '554 applications improve upon previous work and apply to both the Taylor expansion or the global solution (CSI). These solutions may enable improved handling of outliers and better fitting of loss functions to training data.

### Design of PRS Sequences for Cellular Networks

In some cases, 4G and 5G cellular network PRS sequences may implement a Gold Sequence (GS) mapped over subcarriers within one OFDM symbol and continuing over a next OFDM symbol (e.g., and so on). In some such cases, the PRS sequence may be mapped first onto subcarriers then onto symbols (as described with reference to FIG. 6). That is, an OFDM symbol (e.g., column) may be filled vertically (e.g., compacted) before proceeding to the next OFDM symbol (e.g., column). Referring to FIG. 6, the PRS scheduled resources 620 may be denoted by a set of subcarriers and OFDM symbols. The resources 610 can occupy the empty resources of the comb pattern 600 based on repeating the same pattern. For example, FIG. 7 depicts three orthogonal PRS allocations, where each set of subcarriers and symbols associated with a respective TRP (e.g., TRP1, TRP2, TRP3) are illustrated with different patterns.

In some cases, mapping of a GS onto subcarriers of a given set of subcarriers/symbols may not improve orthogonality between different PRS transmitters that use the same set of subcarriers/symbols (i.e., same Resource Elements (RE)). That is, such cases may apply to different beams, different sectors, different cells, etc., Although the mappings could be allocated to different sets of subcarriers/symbols to achieve full orthogonality, there may be a limited quantity of available resources. Thus, it may be useful to improve orthogonality between cells using the same set of subcarriers/symbols or a same RE.

For example, at typical speeds, the receiver of the UE may combine the different OFDM symbols including the PRS of a cell in an analogous processing to the compacting process as described with reference to FIG. 8. Thus, the GS order may not be maintained, and for cells sharing the same subcarriers, orthogonality may not be guaranteed.

In some cases, a mobile network operator planning for PRS IDs may implement many PRS IDs (e.g., from a total of 4096 PRS IDs) to identify and select PRS IDs that are orthogonal for any given multipath delay. If the configuration of a PRS pattern is changed, this selection may be redone because the compacting depends on the PRS pattern. In some examples, if speeds change, the compacting depth used by the receiver may also change and orthogonality may be lost. Embodiments herein disclose a PRS sequence design and mapping that maintains approximate orthogonality regardless of the typical speed, multipath delay, and PRS pattern.

Method for PRS Orthogonality within Same Set of Subcarriers/Symbols

In some embodiments, a GS (or equivalent) may be implemented for low-level scrambling of the PRS sequences to distinguish between far away cells using the similar resources (e.g., the same subcarriers). In some embodiments, for nearby cells where orthogonality is desired, the same GS may be used.

In addition to using a GS for low-level scrambling, for three nearby cells (e.g., three sectors of the same site) that are assigned the same set of resources (e.g., subcarriers and OFDM symbols), a pattern of I/Q constellation rotation in adjacent resources (e.g., subcarriers) may be applied to achieve near orthogonality. The pattern of I/Q constellation rotation in adjacent subcarriers may provide orthogonality regardless of multipath delay.

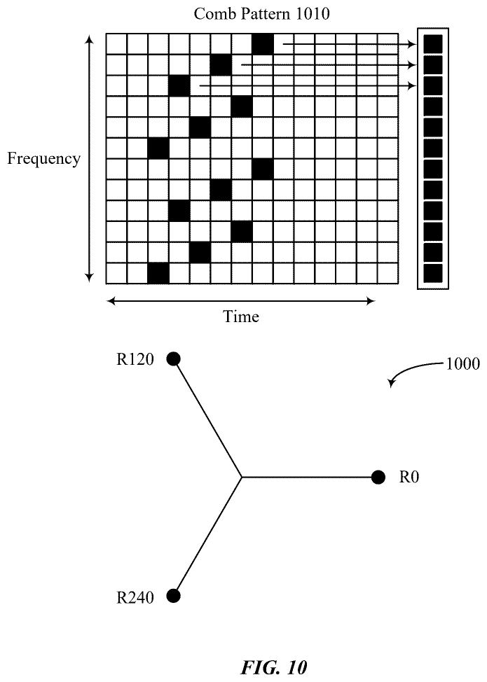

FIG. 10 is an example of I/Q constellation phase rotations 1000 in accordance with one or more implementations as described herein. FIG. 10 also illustrates an example comb pattern 1010, which implements a similar comb-6 pattern to comb pattern 810 as described with reference to FIG. 8. For examples, comb pattern 1010 illustrates three subcarriers (e.g., three top subcarriers) associated with three different OFDM symbols after performing the compacting process as described with reference to FIG. 8. In some such examples, the comb pattern 1010 illustrates the three subcarriers being adjacent to each other within the compacted OFDM symbol.

FIG. 10 also illustrates performing complex rotations for the I/Q symbols. That is, for the TRPs (e.g., TRP1, TRP2, TRP3) using the same set of resources, complex rotations may be applied for the I/Q symbols. Referring to FIG. 10, rotation R0 may correspond to no rotation in the complex plane, whereas rotation R120 may correspond to a rotation of 120 degrees relative to the rotation R0 in the complex plane. Rotation R240 may correspond to a rotation of 240 degrees (e.g., −120 degrees) relative to the rotation R0 or to a rotation of 120 degrees relative to R120 in the complex plane.

For example, for TRP1, the rotations R0, R0, R0 (i.e., no rotations) may be applied to the three adjacent subcarriers. For TRP2, the rotations R240, R0, R120 may be applied for the three adjacent subcarriers. For TRP3, the rotations R120, R0, R240 may be applied. Given these rotations, the PRS sequences may be orthogonal and correlation for one subcarrier may eliminate the other two subcarriers of the three adjacent subcarriers. This process may be applied for any channel (e.g., provided it is not excessively long), as adjacent subcarriers observe an approximately constant channel. Therefore, if the mobile network operator allocates three nearby cells (e.g., three sectors) to the same set of resources, the three cells may exhibit similar delays. Then, applying the pattern of complex I/Q constellation phase rotations 100 may render them orthogonal.

The pattern of I/Q rotations may be selected in different ways. For example, the I/Q rotations may be applied to extend over the range of subcarriers (e.g., not only the three adjacent subcarriers) in a way to ensure that the impulse response of a given cell is orthogonal to that of another cell (e.g., by having their corresponding impulse responses delayed in different ways after undoing the rotation). In some examples, the pattern may also be selected to accommodate two rotations (e.g., for two cells, such as 0 degrees and 180 degrees) or four rotations (e.g., for four cells, such as 0 degrees, 90 degrees, 180 degrees, and 270 degrees), or another variation thereof.

### Case of Long Delays

In some cases, when the delays between different cells extend significantly beyond the duration of one OFDM symbol and corresponding cyclic prefix (CP), the energy from one cell may leak onto another cell even though the cells are using different resources (e.g., different sets of subcarriers and symbols). In some such cases, orthogonal cells (e.g., using different sets of subcarriers and symbols) may interfere with each other. This interference may be exacerbated when a nearby cell is relatively stronger than a far cell. In some examples, a small amount of leaked energy from the strong cell can be sufficient to degrade the quality of the weaker cell. The I/Q rotations may significantly reduce the impact of this problem. As such, if the near and far cells have different I/Q rotations (e.g., provided that the same GS is used), the I/Q rotations may cancel the leaked energy.

In some examples, implementing the I/Q rotations may involve using the same GS. To prevent using the same GS, an additional layer of pseudorandom scrambling may be implemented. For the three adjacent subcarriers, the scrambling may include a unique value for a given cell. However, for another three adjacent subcarriers, the scrambling may include a different value. Implementing the pseudorandom scrambling may improve the overall orthogonality between cells in a random fashion since they are using the same GS. Furthermore, this additional layer of pseudorandom scrambling may be carefully selected in a non-pseudorandom manner to improve orthogonality inter-group where a group consists of three adjacent subcarriers.

In some embodiments, the network operator should distribute the rotations R0, R120, R240 onto three adjacent sectors in a same manner as implemented for the distribution of PSS over three sectors. The primary cell ID for PSS may be the same for sectors pointing in the same direction. The same concepts may be applied for the method disclosed herein. For example, the rotation R0, R0, R0 may be applied to sectors (from different sites) pointing in the same direction. In this manner, the likelihood that the leaked energy has the same rotation (R0, R0, R0) may be reduced. If they have the same rotation, the energy may not cancelled; however, an additional layer of pseudorandom inter-group scrambling may mitigate this issue.

The comb-6 pattern, similar to the comb pattern used in 4G (e.g., but without interrupting the pattern for CRS), may be advantageous as compared to the comb-6 defined in 5G because it allows for greater diversity in cells that interfere with each other. This makes the comb-6 pattern a useful option in some scenarios.

### Zadhoff-Chu Sequences

For some transmitters (e.g., low-cost transmitters) deployed in specific locations for the sole purpose of transmitting positioning reference signals (e.g., with related assistance data), a Peak-to-Average Power Ratio (PAPR) of the general OFDM symbol may be relatively high. Implementing Zadhoff-Chu (ZC) sequences may reduce the PAPR considerably while maintaining an ODFM type of waveform. In some examples, however, there may not be enough ZC sequences to accommodate each transmitter. Therefore, some ZC sequences may be assigned to the low-cost transmitters. Additionally, the remaining transmitters (e.g., excluding the low-cost transmitters) may use the aforementioned method to maintain orthogonality with ZC-type signals.

In some examples, a ZC sequence may be downsampled to 1 per N subcarriers (e.g., comb-6 means N=6) based on the PRS patterns. For example, the ZC sequence may be downsampled by repeating N times in the time domain. In some implementations, N may not be a divisor of the OFDM symbol length, thus the ZC sequence may be generated in the frequency domain over the allocated PRS subcarriers. Likewise, an inverse Fourier transform associated with the ZC sequence may be a repeated ZC sequence with sufficient PAPR properties. In other examples, by using N=1, 2, 4, or 8, N may be a divisor of the OFDM symbol length, and therefore the ZC sequence may be exact in the time domain (e.g., provided that the ZC sequence length is not a prime number). It is noted that current 3GPP specifications describe a comb of N=2, 4, 6, or 12. In some embodiments, when using a ZC sequence for some transmitters, the GS may not be applied or may be assumed as equal to the ZC sequence, or to an all one sequence.

### Qualifying TOA Measurements for Position Estimation

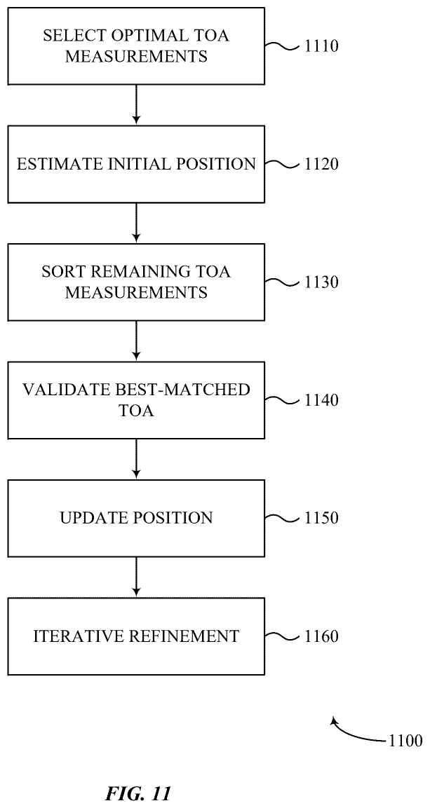

FIG. 11 illustrates an example process 1100 for using network assistance data to qualify time of arrival measurements for position estimation in accordance with one or more implementations described herein. Process 1100 may be implemented by one or more devices of a network including at least a UE, a base station, a TRP, a centralized platform, or other devices, or any combination thereof. Process 1100 illustrates a method for using network assistance data (e.g., PRS configuration data, muting patterns, tower locations, or other assistance data) to qualify TOA measurements for UE position estimation.

In some examples, the process 1100 may include one or more other operations not illustrated in FIG. 11; one or more operations in a different order than illustrated by FIG. 11; or one or more fewer operations than illustrated in FIG. 11, or any combination thereof. Additionally, or alternatively, the process 1100 may implement one or more operations that are performed at least partially independently, sequentially, or concurrently, or any combination thereof with reference to a location, device, or time of each of the one or more operations.

As shown in process 1100, a UE (e.g., or another network entity) may select optimal TOA measurements (at block 1110). For example, the UE may identify a list of TOA measurements and associated assistance data. In some examples, the list of TOA measurements may be identified based on performing the TOA measurements or based on receiving the list from one or more other network entities (e.g., one or more base stations, one or more cells, one or more TRPs). In some examples, the associated assistance data may include PRS configuration data, an indication of muting patterns for the PRSs, locations of the one or more other network entities, or other data, or any combination thereof. After identifying the list of TOA measurements and the associated assistance data, the UE may identify a subset of TOA measurements of the list of TOA measurements. The subset of TOA measurements may include TOAs associated with PRSs that have the highest orthogonality of the list of TOA measurements. That is, the UE may select the optimal TOA measurements by identifying the subset of TOA measurements (e.g., the optimal TOA measurements) associated with the highest orthogonality (e.g., the most optimal parameters) from the list of TOA measurements.

Process 1100 may include estimating an initial position of the UE using the subset of TOA measurements (at block 1120). That is, the UE may estimate the position of the UE based on the selected TOA measurements of the list of TOA measurements. After estimating the initial position of the UE, process 1100 may include determining the confidence level. For example, the UE may determine a confidence level that the initial position of the UE is accurate based on estimating the initial position of the UE.

Process 1100 may include sorting the remaining TOA measurements (at block 1130). For example, the UE may sort the remaining TOA measurements included in the list of measurements excluding the TOA measurements selected for the subset (e.g., at block 1110). The remaining TOA measurements may be affected by interference due to imperfect orthogonality, network planning, or network entity location constraints (e.g., constraints associated with the locations of the one or more other network entities). In some examples, the UE may sort the remaining TOA measurements based on a level of matching between the measured TOA and the predicted TOA associated with each remaining TOA measurement. In some such examples, the measured TOA and the predicted TOA may be based at least partially on the initial position estimated for the UE. That is, the UE may sort the remaining TOA measurements based on the matching between the measured TOA and the predicted TOA using the latest estimated UE position (e.g., from block 1120).

Process 1100 may include validating the best matched TOA (at block 1140). That is, the UE may select the TOA measurement with the highest level of matching between the measured TOA and the predicted TOA based on the estimated initial position. Then, the UE may evaluate the selected TOA measurement using the confidence level associated with estimated initial position. In some examples, the UE may evaluate the selected TOA measurement based on noise statistics. In some implementations, the UE may apply statistical tests (e.g., Chi-Squared or robust methods) to assess the consistency.

After validating the best matched TOA, process 1100 may include updating the position of the UE (at block 1150). In some examples, the UE may determine whether the TOA has passed validation and update the position of the UE and the confidence level accordingly. For example, the UE may determine that the TOA is validated and the UE may estimate the updated position based on the validated TOA. After determining the updated position, the UE may determine the confidence level that the updated position of the UE is accurate based on estimating the updated position of the UE using the validated TOA.

Process 1100 may include repeating operations of process 1100 for iterative refinement (at block 1160). For example, process 1100 may include repetitively performing the operations of block 1140 and block 1150 a quantity of times. That is, block 1160 may represent the repetition of block 1140 and block 1150, such that iterative refinement may include repeating the operations of block 1140 and block 1150 one or more times to refine the position of the UE. As an example, the UE may select the next best matched TOA (e.g., a second best matched TOA) and validate the next best matched TOA. Then, the UE may update the position of the UE based on the next best matched TOA, and determine a confidence level of the updated position. In some examples, the UE may repeat these operations until each relevant TOA measurement has been processed.

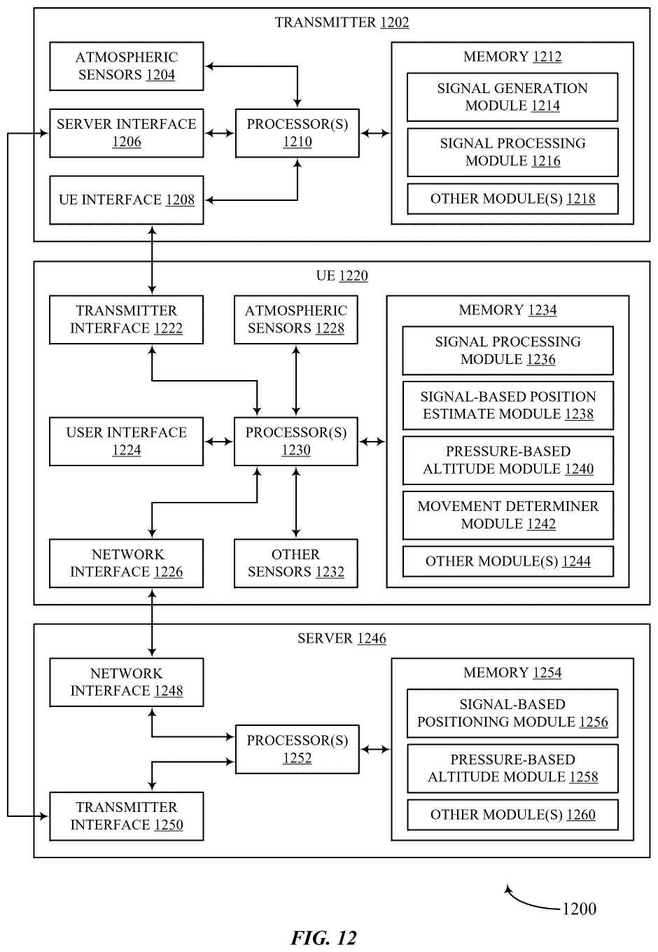

FIG. 12 illustrates an example device diagram 1200 including a transmitter 1202, a UE 1220, and a server 1246, in accordance with one or more implementations described herein. The transmitter 1202 may be an example of a network entity 110 (e.g., a base station, a node, a TRP) as described with reference to FIG. 1. The UE 1220 may be an example of a UE 120 (e.g., a mobile device, a wireless device) as described with reference to FIG. 1. The server 1246 may be an example of a centralized platform 130 as described with reference to FIG. 1.

By way of example in FIG. 12, transmitter 1202 (e.g., any transmitter such terrestrial PNT beacons, among others) discussed herein may include: a UE interface 1208 for exchanging information with the UE 1220 (or a UE timing receiver) (e.g., antenna(s) and RF front end components known in the art or otherwise disclosed herein); one or more processor(s) 1210 which may include one or more controllers for facilitating operations of the transmitter 1202; a memory 1212 (e.g., a data storage component) coupled to the one or more processors 1210 for providing storage and retrieval of information and/or program instructions; atmospheric sensor(s) 1204 (e.g., altitude stations 140) for measuring environmental conditions (e.g., pressure, temperature, humidity, other) at or near the transmitter 1202; a server interface 1206 for exchanging information with the server 1246 (e.g., a receiver assistance server(s), a TWTT server) (e.g., an antenna, a network interface, or other); and any other components known to one of ordinary skill in the art. The memory 1212 may include memory storing data and software modules with executable instructions, including a signal generation module 1214, a signal processing module 1216, and other modules 1218.

The memory 1212 may include memory storing software modules with executable instructions, and the one or more processor(s) 1210 may perform different actions by executing the instructions from the modules, including: (i) performance of part or all of the methods as described herein or otherwise understood by one of skill in the art as being performable at the transmitter 1202; (ii) generation of positioning signals for transmission using a selected time, frequency, code, and/or phase (e.g., associated with the signal generation module 1214); (iii) processing of signaling received from the UE 1220, the server 1246, or another source (e.g., associated with the signal processing module 1216); or (iv) other processing as required by operations described in this disclosure (e.g., associated with the other modules 1218). Steps performed by the transmitter 1202 as described herein may also be performed on other machines that are remote from the transmitter 1202, including the UE 1220, the server 1246, computers of enterprises, or any other suitable machine. Signals generated and transmitted by the transmitter 1202 may carry different information that, once determined by the UE 1220 or the server 1246, may identify the following: the transmitter 1202; the transmitter's position; environmental conditions at or near the transmitter 1202; the UE 1220; the UE's position; environmental conditions at or near the UE 1220; and/or other information known in the art. The atmospheric sensor(s) 1204 may be integral with the transmitter 1202 or separate from the transmitter 1202, and/or co-located with the transmitter 1202 or located in the vicinity of the transmitter 1202 (e.g., within a threshold amount of distance).

By way of example in FIG. 12, the UE 1220 may include a network interface 1226 for exchanging information with the server 1246 via a network (e.g., a network 100) (e.g., a wired and/or a wireless interface port, an antenna, and RF front end components known in the art or otherwise disclosed herein); one or more processor(s) 1230 which may include one or more controllers for facilitating operations of the UE 1220; a memory 1234 (e.g., a data storage component) for providing storage and retrieval of information and/or program instructions; atmospheric sensor(s) 1228 for measuring environmental conditions (e.g., pressure, temperature, other) at the UE 1220; other sensor(s) 1232 for measuring other conditions (e.g., compass, accelerometer and inertial sensors for measuring movement and orientation); a user interface 924 (e.g., display, keyboard, microphone, speaker, other) for permitting the user of the UE 1220 to provide inputs and receive outputs; a transmitter interface 1222 for exchanging information with the transmitter 1202 (e.g., a wired and/or wireless interface port, an antenna, and RF front end components known in the art or otherwise disclosed herein); and any other components known to one of ordinary skill in the art. A GNSS interface and processing unit (not shown) are contemplated, which may be integrated with other components or a stand-alone antenna, RF front end, and processors dedicated to receiving and processing GNSS signaling. The memory 1234 may include memory storing data and software modules with executable instructions, including a signal processing module 1236, a signal-based position estimate module 1238, a pressure-based altitude module 1240, a movement determination module 1242, a data packet, and other modules 1244.

The processor(s) 1230 may perform different actions by executing the instructions from the modules, including: (i) performance of part or all of the methods, processes and techniques as described herein or otherwise understood by one of ordinary skill in the art as being performable at the UE 1220; (ii) processing of signaling received from the transmitter 1202, the server 1246, or another source (e.g., associated with the signal processing module 1236); (iii) estimation of an altitude of the UE 1220 (e.g., associated with the pressure-based altitude module 1240); (iv) computation of an estimated position of the UE 1220 (e.g., associated with the signal-based position estimate module 1238); (v) determination of movement of the UE 1220 (e.g., associated with the movement determiner module 1242); (vi) performance of calibration techniques; (vii) calibration of the UE 1220; (viii) determination of calibration conduciveness for a calibration opportunity; or (ix) other processing as required by operations or processes described in this disclosure (e.g., associated with the other modules 1244). Steps performed by the UE 1220 as described herein may also be performed on other machines that are remote from the UE 1220, including the transmitter 1202, the server 1246, computers of enterprises, or any other suitable machine. Signals generated and transmitted by the UE 1220 may carry different information that, once determined by the transmitter 1202 or the server 1246, may identify the following: the UE 1220; the UE's position; environmental conditions at or near the UE 1220; the transmitter 1202; the transmitter's position; environmental conditions at or near the transmitter 1202; and/or other information known in the art.

By way of example in FIG. 12, the server 1246 may include: a network interface 1248 for exchanging information with the UE 1220 and other sources of data via the network (e.g., a wired and/or a wireless interface port, an antenna, or other); one or more processor(s) 1252 which may include one or more controllers for facilitating operations of the server 1246; a memory 1254 (e.g., a data storage component) for providing storage and retrieval of information and/or program instructions; a transmitter interface 1250 for exchanging information with the transmitter 1202 and other sources of data via the network (e.g., a wired and/or a wireless interface port, an antenna, or other); and any other components known to one of ordinary skill in the art. The memory 1254 may include memory storing software modules with executable instructions, including a signal-based positioning module 1256, a pressure-based altitude module 1258, as well as other modules 1260 for each of the above-described methods and processes or portions/steps thereof.

The processor(s) 1252 may perform different actions by executing instructions from the modules, including: (i) performance of part or all of the methods, processes, and techniques as described herein or otherwise understood by one of ordinary skill in the art as being performable at the server 1246; (ii) processing of signaling received from the transmitter 1202, the UE 1220, or another source (e.g., associated with the signal processing module 1256); (iii) estimation of an altitude of the UE 1220 (e.g., associated with the pressure-based altitude module 1258); (iv) computation of an estimated position of the UE 1220; or (v) other processing as required by operations or processes described in this disclosure (e.g., associated with the other modules 1260). Steps performed by the server 1246 as described herein may also be performed on other machines that are remote from the server 1246, including the transmitter 1202, the UE 1220, computers of enterprises, or any other suitable machine. Signals generated and transmitted by the server 1246 may carry different information that, once determined by the transmitter 1202 or the UE 1220, may identify the following: the UE 1220; the UE's position; environmental conditions at or near the UE 1220; the transmitter 1202; the transmitter's position; environmental conditions at or near the transmitter 1202; and/or other information known in the art.

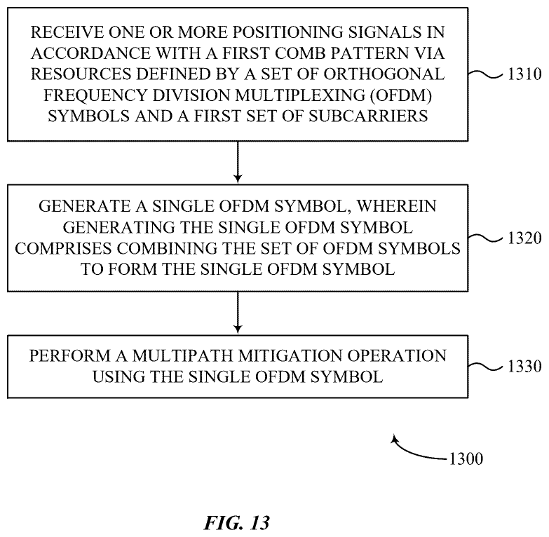

FIG. 13 illustrates an example of a process 1300 that supports multipath mitigation, interference cancellation and multilateration in a cellular network supporting accurate and resilient PNT services in accordance with one or more implementations described herein. The process 1300 may be implemented by a network (e.g., a network 100), a network entity (e.g., a network entity 110), a centralized platform (e.g., a centralized platform 130), a UE (e.g., a UE 120), or one or more other systems or devices, or any combination thereof. That is, the process 1300 may be implemented by one or more devices as described with reference to FIG. 1.

In some cases, the process 1300 may illustrate operations, processes, or aspects of devices described herein, including the devices as described with reference to FIG. 12. In some examples, the process 1300 may include one or more other operations not illustrated in FIG. 13; one or more operations in a different order than illustrated by FIG. 13; or one or more fewer operations than illustrated in FIG. 13, or any combination thereof. Additionally, or alternatively, the process 1300 may implement one or more operations in which the one or more operations are performed at least partially independently, sequentially, or concurrently, or any combination thereof with reference to a location, device, or time of each of the one or more operations. As such, the process 1300 may be indicative of techniques not limited by the number, sequence, arrangement, timing, etc., of the operations illustrated in FIG. 13.

The process 1300 may be implemented at user equipment (UE). The process 1300 may include receiving one or more positioning signals in accordance with a first comb pattern via resources defined by a set of orthogonal frequency division multiplexing (OFDM) symbols and a first set of subcarriers, wherein the set of OFDM symbols includes one or more OFDM symbols (block 1310). The process 1300 may include generating a single OFDM symbol, wherein generating the single OFDM symbol comprises combining the set of OFDM symbols to form the single OFDM symbol (block 1320). The process 1300 may include performing a multipath mitigation operation using the single OFDM symbol (block 1330).

Examples and/or embodiments described herein may include subject matter which may be implemented as a method, means for performing acts (e.g., operations, processes) or blocks of the method, at least one machine-readable medium including executable instructions that, when performed by a machine (e.g., one or more processors, one or more controllers, etc.) with memory, (e.g., an application-specific integrated circuit (ASIC), a field programmable gate array (FPGA), or the like) cause the machine to perform acts of the method or of an apparatus or system for concurrent communication using multiple communication technologies according to embodiments and examples described.

In example 1, which may also include one or more of the examples described herein, a method at a user equipment (UE) may include: receiving one or more positioning signals in accordance with a first comb pattern via resources defined by a set of orthogonal frequency division multiplexing (OFDM) symbols and a first set of subcarriers, where the set of OFDM symbols includes one or more OFDM symbols; generating a single OFDM symbol, where generating the single OFDM symbol may include combining the set of OFDM symbols to form the single OFDM symbol; and performing a multipath mitigation operation using the single OFDM symbol.

In example 2, which may also include one or more of the examples described herein, generating the single OFDM symbol may include: applying a respective fast-Fourier transform (FFT) to each OFDM symbol of the set of OFDM symbols; extracting, based on applying the FFTs to the set of OFDM symbols, the first set of subcarriers associated with receiving the one or more positioning signals from the set of OFDM symbols; descrambling the OFDM symbols; and combining the set of OFDM symbols based on compacting the time between the OFDM symbols of the set of OFDM symbols to form the single OFDM symbol.

In example 3, which may also include one or more of the examples described herein, the one or more positioning signals are received from a first network entity, and the method further may include: receiving one or more second positioning signals in accordance with a second comb pattern via second resources defined by a second set of OFDM symbols, and a second set of subcarriers, where the second set of OFDM symbols includes one or more OFDM symbols; and generating a second single OFDM symbol, where generating the second single OFDM symbol may include combining the second set of OFDM symbols to form the second single OFDM symbol.

In example 4, which may also include one or more of the examples described herein, the second comb pattern is the same as the first comb pattern; the set of OFDM symbols is associated with a first slot and the second set of OFDM symbols is associated with a second slot following the first slot; and the second set of subcarriers is the same as the first set of subcarriers.

In example 5, which may also include one or more of the examples described herein, the first comb pattern is one of a plurality of comb patterns associated with receiving the one or more positioning signals, each comb pattern including a respective set of OFDM symbols and a set of subcarriers for receiving the one or more positioning signals, where each comb pattern includes a different quantity of OFDM symbols in the respective set of OFDM symbols and a same quantity of subcarriers of the respective set of subcarriers.

In example 6, which may also include one or more of the examples described herein, the one or more positioning signals are received from a first network entity, and the method further may include: receiving, from a second network entity, one or more second positioning signals in accordance with a second comb pattern via second resources defined by the set of OFDM symbols and the first set of subcarriers; and receiving, from a third network entity, one or more third positioning signals in accordance with a third comb pattern via third resources defined by the set of OFDM symbols and the first set of subcarriers.

In example 7, which may also include one or more of the examples described herein, the method may include: correcting a clock frequency offset of the UE, where generating the single OFDM symbol is based on correcting the clock frequency offset of the UE.

In example 8, which may also include one or more of the examples described herein, performing the multipath mitigation operation further may include: performing code-based multipath mitigation using a time of arrival matched filter to shape a frequency domain and a time domain impulse response.

In example 9, which may also include one or more of the examples described herein, the method may include: applying, based on generating the single OFDM symbol, a pattern of constellation rotations to I/Q symbols of adjacent subcarriers of the first set of subcarriers.

In example 10, which may also include one or more of the examples described herein, the adjacent subcarriers are associated with more than one sector of a site and are associated with the same resources.

In example 11, which may also include one or more of the examples described herein, the method may include: pseudorandom scrambling one or more subcarriers of the first set of subcarriers using a pseudorandom scrambling sequence.

In example 12, which may also include one or more of the examples described herein, the pseudorandom scrambling sequence is selected to be the same when the one or more subcarriers are adjacent subcarriers of the first set of subcarriers; and the pseudorandom scrambling sequence is selected to be different when the one or more subcarriers are not adjacent subcarriers.

In example 13, which may also include one or more of the examples described herein, the method may include: identifying a subset of time of arrival (TOA) measurements of a set of TOA measurements based on receiving the one or more positioning signals; estimating an initial position of the UE using the subset of TOA measurements; selecting a remaining TOA measurement of the set of TOA measurements based on sorting the remaining TOA measurements excluding the subset of TOA measurements; and updating the estimated position of the UE using the selected remaining TOA measurement.

In example 14, which may also include one or more of the examples described herein, identifying the subset of TOA measurements may include identifying TOA measurements of the set of TOA measurements with relatively highest orthogonality; estimating the initial position may include determining a confidence level that the estimated position of the UE is accurate; and selecting the remaining TOA measurement may include identifying the TOA measurement with the relatively highest level of matching between measured TOA and predicted TOA associated with each remaining TOA measurement.

In example 15, which may also include one or more of the examples described herein, the single OFDM symbol may include the first set of subcarriers.

In example 16, which may also include one or more of the examples described herein, a user equipment (UE) may include one or more processors configured to: receive one or more positioning signals in accordance with a first comb pattern via resources defined by a set of orthogonal frequency division multiplexing (OFDM) symbols and a first set of subcarriers, where the set of OFDM symbols includes one or more OFDM symbols; generate a single OFDM symbol, where generating the single OFDM symbol may include combining the set of OFDM symbols to form the single OFDM symbol; and perform a multipath mitigation operation using the single OFDM symbol.

In example 17, which may also include one or more of the examples described herein, the one or more processors, when generating the single OFDM symbol, are configured to: apply a respective fast-Fourier transform (FFT) to each OFDM symbol of the set of OFDM symbols; extract, based on applying the FFTs to the set of OFDM symbols, the first set of subcarriers associated with receiving the one or more positioning signals from the set of OFDM symbols; descramble the OFDM symbols; and combine the set of OFDM symbols based on compacting the time between the OFDM symbols of the set of OFDM symbols to form the single OFDM symbol.

In example 18, which may also include one or more of the examples described herein, the one or more positioning signals are received from a first network entity, and the one or more processors are further configured to: receive one or more second positioning signals in accordance with a second comb pattern via second resources defined by a second set of OFDM symbols, and a second set of subcarriers, where the second set of OFDM symbols includes one or more OFDM symbols; and generate a second single OFDM symbol, where generating the second single OFDM symbol may include combining the second set of OFDM symbols to form the second single OFDM symbol.

In example 19, which may also include one or more of the examples described herein, the second comb pattern is the same as the first comb pattern; the set of OFDM symbols is associated with a first slot and the second set of OFDM symbols is associated with a second slot follow the first slot; and the second set of subcarriers is the same as the first set of subcarriers.

In example 20, which may also include one or more of the examples described herein, the first comb pattern is one of a plurality of comb patterns associated with receiving the one or more positioning signals, each comb pattern including a respective set of OFDM symbols and a set of subcarriers for receiving the one or more positioning signals, each comb pattern includes a different quantity of OFDM symbols in the respective set of OFDM symbols and a same quantity of subcarriers of the respective set of subcarriers.

In example 21, which may also include one or more of the examples described herein, the one or more positioning signals are received from a first network entity, and the one or more processors are further configured to: receive, from a second network entity, one or more second positioning signals in accordance with a second comb pattern via second resources defined by the set of OFDM symbols and the first set of subcarriers; and receive, from a third network entity, one or more third positioning signals in accordance with a third comb pattern via third resources defined by the set of OFDM symbols and the first set of subcarriers.

In example 22, which may also include one or more of the examples described herein, the one or more processors are further configured to: correct a clock frequency offset of the UE; and where generate the single OFDM symbol is based on correcting the clock frequency offset of the UE.

In example 23, which may also include one or more of the examples described herein, the one or more processors, when performing the multipath mitigation operation, are configured to: perform code-based multipath mitigation using a time of arrival matched filter to shape a frequency domain and a time domain impulse response.

In example 24, which may also include one or more of the examples described herein, the one or more processors are further configured to: apply, based on generating the single OFDM symbol, a pattern of constellation rotations to I/Q symbols of adjacent subcarriers of the first set of subcarriers.

In example 25, which may also include one or more of the examples described herein, the adjacent subcarriers are associated with more than one sector of a site and are associated with the same resources.

In example 26, which may also include one or more of the examples described herein, the one or more processors are further configured to: pseudorandom scramble one or more subcarriers of the first set of subcarriers using a pseudorandom scrambling sequence.

In example 27, which may also include one or more of the examples described herein, the pseudorandom scramble sequence is selected to be the same when the one or more subcarriers are adjacent subcarriers of the first set of subcarriers; and the pseudorandom scramble sequence is selected to be different when the one or more subcarriers are not adjacent subcarriers.

In example 28, which may also include one or more of the examples described herein, the one or more processors are further configured to: identify a subset of time of arrival (TOA) measurements of a set of TOA measurements based on receiving the one or more positioning signals; estimate an initial position of the UE using the subset of TOA measurements; select a remaining TOA measurement of the set of TOA measurements based on sorting the remaining TOA measurements excluding the subset of TOA measurements; and update the estimated position of the UE using the selected remaining TOA measurement.

In example 29, which may also include one or more of the examples described herein, identifying the subset of TOA measurements may include identifying TOA measurements of the set of TOA measurements with relatively highest orthogonality; estimating the initial position may include determining a confidence level that the estimated position of the UE is accurate; and selecting the remaining TOA measurement may include identifying the TOA measurement with the relatively highest level of matching between measured TOA and predicted TOA associated with each remaining TOA measurement.

In example 30, which may also include one or more of the examples described herein, the single OFDM symbol may include the first set of subcarriers.

In example 31, which may also include one or more of the examples described herein, a non-transitory computer-readable medium may be configured to store one or more instructions. The one or more instructions, when executed by one or more processors of an electronic device, may cause the electronic device to: receive one or more positioning signals in accordance with a first comb pattern via resources defined by a set of orthogonal frequency division multiplexing (OFDM) symbols and a first set of subcarriers, where the set of OFDM symbols includes one or more OFDM symbols; generate a single OFDM symbol, where generating the single OFDM symbol may include combining the set of OFDM symbols to form the single OFDM symbol; and perform a multipath mitigation operation using the single OFDM symbol.

In example 32, which may also include one or more of the examples described herein, when generating the single OFDM symbol, the one or more instructions, when executed by the one or more processors, cause the electronic device to: apply a respective fast-Fourier transform (FFT) to each OFDM symbol of the set of OFDM symbols; extract, based on applying the FFTs to the set of OFDM symbols, the first set of subcarriers associated with receiving the one or more positioning signals from the set of OFDM symbols; descramble the OFDM symbols; and combine the set of OFDM symbols based on compacting the time between the OFDM symbols of the set of OFDM symbols to form the single OFDM symbol.

In example 33, which may also include one or more of the examples described herein, the one or more positioning signals are received from a first network entity, and the one or more instructions, when executed by the one or more processors, further cause the electronic device to: receive one or more second positioning signals in accordance with a second comb pattern via second resources defined by a second set of OFDM symbols, and a second set of subcarriers, where the second set of OFDM symbols includes one or more OFDM symbols; and generate a second single OFDM symbol, where generating the second single OFDM symbol may include combining the second set of OFDM symbols to form the second single OFDM symbol.

In example 34, which may also include one or more of the examples described herein, the one or more instructions, when executed by the one or more processors, further cause the electronic device to: the second comb pattern is the same as the first comb pattern; the set of OFDM symbols is associated with a first slot and the second set of OFDM symbols is associated with a second slot follow the first slot; and the second set of subcarriers is the same as the first set of subcarriers.

In example 35, which may also include one or more of the examples described herein, the first comb pattern is one of a plurality of comb patterns associated with receiving the one or more positioning signals, each comb pattern including a respective set of OFDM symbols and a set of subcarriers for receiving the one or more positioning signals, each comb pattern includes a different quantity of OFDM symbols in the respective set of OFDM symbols and a same quantity of subcarriers of the respective set of subcarriers.

In example 36, which may also include one or more of the examples described herein, the one or more positioning signals are received from a first network entity, and the one or more instructions, when executed by the one or more processors, further cause the electronic device to: receive, from a second network entity, one or more second positioning signals in accordance with a second comb pattern via second resources defined by the set of OFDM symbols and the first set of subcarriers; and receive, from a third network entity, one or more third positioning signals in accordance with a third comb pattern via third resources defined by the set of OFDM symbols and the first set of subcarriers.

In example 37, which may also include one or more of the examples described herein, the one or more instructions, when executed by the one or more processors, further cause the electronic device to: correct a clock frequency offset of the UE; and where generate the single OFDM symbol is based on correcting the clock frequency offset of the UE.

In example 38, which may also include one or more of the examples described herein, when performing the multipath mitigation operation, the one or more instructions, when executed by the one or more processors, cause the electronic device to: perform code-based multipath mitigation using a time of arrival matched filter to shape a frequency domain and a time domain impulse response.

In example 39, which may also include one or more of the examples described herein, the one or more instructions, when executed by the one or more processors, further cause the electronic device to: apply, based on generating the single OFDM symbol, a pattern of constellation rotations to I/Q symbols of adjacent subcarriers of the first set of subcarriers.

In example 40, which may also include one or more of the examples described herein, the adjacent subcarriers are associated with more than one sector of a site and are associated with the same resources.

In example 41, which may also include one or more of the examples described herein, the one or more instructions, when executed by the one or more processors, further cause the electronic device to: pseudorandom scramble one or more subcarriers of the first set of subcarriers using a pseudorandom scrambling sequence.

In example 42, which may also include one or more of the examples described herein, the pseudorandom scramble sequence is selected to be the same when the one or more subcarriers are adjacent subcarriers of the first set of subcarriers; and the pseudorandom scramble sequence is selected to be different when the one or more subcarriers are not adjacent subcarriers.

In example 43, which may also include one or more of the examples described herein, the one or more instructions, when executed by the one or more processors, further cause the electronic device to: identify a subset of time of arrival (TOA) measurements of a set of TOA measurements based on receiving the one or more positioning signals; estimate an initial position of the UE using the subset of TOA measurements; select a remaining TOA measurement of the set of TOA measurements based on sorting the remaining TOA measurements excluding the subset of TOA measurements; and update the estimated position of the UE using the selected remaining TOA measurement.

In example 44, which may also include one or more of the examples described herein, identifying the subset of TOA measurements may include identifying TOA measurements of the set of TOA measurements with relatively highest orthogonality; estimating the initial position may include determining a confidence level that the estimated position of the UE is accurate; and selecting the remaining TOA measurement may include identifying the TOA measurement with the relatively highest level of matching between measured TOA and predicted TOA associated with each remaining TOA measurement.

In example 45, which may also include one or more of the examples described herein, the single OFDM symbol may include the first set of subcarriers.

In example 46, which may also include one or more of the examples described herein, the method may include performing an interference cancellation operation of one or more OFDM symbols overlapped in time and frequency, where performing the interference cancellation operation is based at least partially on generating the single OFDM symbol.

In example 47, which may also include one or more of the examples described herein, the one or more processors are further configured to: perform an interference cancellation operation of one or more OFDM symbols overlapped in time and frequency, where performing the interference cancellation operation is based at least partially on generating the single OFDM symbol.

In example 48, which may also include one or more of the examples described herein, the one or more instructions, when executed by the one or more processors, further cause the electronic device to: perform an interference cancellation operation of one or more OFDM symbols overlapped in time and frequency, where performing the interference cancellation operation is based at least partially on generating the single OFDM symbol.

In example 49, which may also include one or more of the examples described herein, performing the interference cancellation operation further may include: performing a quantity of channel estimations associated with one or more cells; and iteratively subtracting the quantity of channel estimations from the one or more positioning signals based on a level of interference associated with the quantity of channel estimations.

In example 50, which may also include one or more of the examples described herein, to perform the interference cancellation operation, the one or more processors are further configured to: perform a quantity of channel estimations associated with one or more cells; and iteratively subtract the quantity of channel estimations from the one or more positioning signals based on a level of interference associated with the quantity of channel estimations.

In example 51, which may also include one or more of the examples described herein, the one or more instructions to perform the interference cancellation operation, when executed by the one or more processors, further cause the electronic device to: perform a quantity of channel estimations associated with one or more cells; and iteratively subtract the quantity of channel estimations from the one or more positioning signals based on a level of interference associated with the quantity of channel estimations.

In example 52, which may also include one or more of the examples described herein, the method may include: qualifying multiple OFDM symbols from multiple transmission reception points (TRPs); and performing iterative position updates based on sorting the multiple OFDM symbols.

In example 53, which may also include one or more of the examples described herein, the one or more processors are further configured to: qualify multiple OFDM symbols from multiple transmission reception points (TRPs); and perform iterative position updates based on sorting the multiple OFDM symbols.

In example 54, which may also include one or more of the examples described herein, the one or more instructions, when executed by the one or more processors, further cause the electronic device to: qualify multiple OFDM symbols from multiple transmission reception points (TRPs); and perform iterative position updates based on sorting the multiple OFDM symbols.

Reference has been made in detail to embodiments of the disclosed invention. Each example has been provided by way of an explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

The examples discussed above also extend to method, computer-readable medium, and means-plus-function claims and implementations, any of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art may recognize.

In this regard, while the disclosed subject matter has been described in connection with various examples, implementations, aspects, etc., and corresponding Figures, where applicable, it is to be understood that other similar aspects may be used or modifications and additions may be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct, or they may be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed:

1. A method at a user equipment (UE) comprising:
receiving one or more positioning signals in accordance with a first comb pattern via resources defined by a set of orthogonal frequency division multiplexing (OFDM) symbols and a first set of subcarriers, wherein the set of OFDM symbols includes one or more OFDM symbols;
generating a single OFDM symbol, wherein generating the single OFDM symbol comprises combining the set of OFDM symbols to form the single OFDM symbol; and
performing a multipath mitigation operation using the single OFDM symbol.

2. The method of claim 1, wherein generating the single OFDM symbol comprises:
applying a respective fast-Fourier transform (FFT) to each OFDM symbol of the set of OFDM symbols;
extracting, based on applying the FFTs to the set of OFDM symbols, the first set of subcarriers associated with receiving the one or more positioning signals from the set of OFDM symbols;
descrambling the OFDM symbols; and
combining the set of OFDM symbols based on compacting the time between the OFDM symbols of the set of OFDM symbols to form the single OFDM symbol.

3. The method of claim 1, wherein the one or more positioning signals are received from a first network entity, and the method further comprises:
receiving one or more second positioning signals in accordance with a second comb pattern via second resources defined by a second set of OFDM symbols, and a second set of subcarriers, wherein the second set of OFDM symbols includes one or more OFDM symbols; and
generating a second single OFDM symbol, wherein generating the second single OFDM symbol comprises combining the second set of OFDM symbols to form the second single OFDM symbol.

4. The method of claim 3, wherein:
the second comb pattern is the same as the first comb pattern;
the set of OFDM symbols is associated with a first slot and the second set of OFDM symbols is associated with a second slot following the first slot; and
the second set of subcarriers is the same as the first set of subcarriers.

5. The method of claim 1, wherein the first comb pattern is one of a plurality of comb patterns associated with receiving the one or more positioning signals, each comb pattern including a respective set of OFDM symbols and a set of subcarriers for receiving the one or more positioning signals, wherein each comb pattern includes a different quantity of OFDM symbols in the respective set of OFDM symbols and a same quantity of subcarriers of the respective set of subcarriers.

6. The method of claim 1, wherein the one or more positioning signals are received from a first network entity, and the method further comprises:
receiving, from a second network entity, one or more second positioning signals in accordance with a second comb pattern via second resources defined by the set of OFDM symbols and the first set of subcarriers; and
receiving, from a third network entity, one or more third positioning signals in accordance with a third comb pattern via third resources defined by the set of OFDM symbols and the first set of subcarriers.

7. The method of claim 1, further comprising:
correcting a clock frequency offset of the UE,
wherein generating the single OFDM symbol is based on correcting the clock frequency offset of the UE.

8. The method of claim 1, wherein performing the multipath mitigation operation further comprises:
performing code-based multipath mitigation using a time of arrival matched filter to shape a frequency domain and a time domain impulse response.

9. The method of claim 1, further comprising:
applying, based on generating the single OFDM symbol, a pattern of constellation rotations to I/Q symbols of adjacent subcarriers of the first set of subcarriers.

10. The method of claim 9, wherein the adjacent subcarriers are associated with more than one sector of a site and are associated with the same resources.

11. The method of claim 1, further comprising:
pseudorandom scrambling one or more subcarriers of the first set of subcarriers using a pseudorandom scrambling sequence.

12. The method of claim 11, wherein:
the pseudorandom scrambling sequence is selected to be the same when the one or more subcarriers are adjacent subcarriers of the first set of subcarriers; and
the pseudorandom scrambling sequence is selected to be different when the one or more subcarriers are not adjacent subcarriers.

13. The method of claim 1, further comprising:
identifying a subset of time of arrival (TOA) measurements of a set of TOA measurements based on receiving the one or more positioning signals;
estimating an initial position of the UE using the subset of TOA measurements;
selecting a remaining TOA measurement of the set of TOA measurements based on sorting the remaining TOA measurements excluding the subset of TOA measurements; and
updating the estimated position of the UE using the selected remaining TOA measurement.

14. The method of claim 13, wherein:
identifying the subset of TOA measurements comprises identifying TOA measurements of the set of TOA measurements with relatively highest orthogonality;
estimating the initial position comprises determining a confidence level that the estimated position of the UE is accurate; and
selecting the remaining TOA measurement comprises identifying the TOA measurement with the relatively highest level of matching between measured TOA and predicted TOA associated with each remaining TOA measurement.

15. The method of claim 1, wherein the single OFDM symbol comprises the first set of subcarriers.

16. The method of claim 1, further comprising:
performing an interference cancellation operation of one or more OFDM symbols overlapped in time and frequency,
wherein performing the interference cancellation operation is based at least partially on generating the single OFDM symbol.

17. The method of claim 16, wherein performing the interference cancellation operation further comprises:
performing a quantity of channel estimations associated with one or more cells; and
iteratively subtracting the quantity of channel estimations from the one or more positioning signals based on a level of interference associated with the quantity of channel estimations.

18. The method of claim 1, further comprising:
qualifying multiple OFDM symbols from multiple transmission reception points (TRPs); and
performing iterative position updates based on sorting the multiple OFDM symbols.

19. A user equipment (UE) comprising:
one or more processors configured to:
receive one or more positioning signals in accordance with a first comb pattern via resources defined by a set of orthogonal frequency division multiplexing (OFDM) symbols and a first set of subcarriers, wherein the set of OFDM symbols includes one or more OFDM symbols;
generate a single OFDM symbol, wherein generating the single OFDM symbol comprises combining the set of OFDM symbols to form the single OFDM symbol; and
perform a multipath mitigation operation using the single OFDM symbol.

20. A non-transitory computer-readable medium storing one or more instructions that, when executed by one or more processors of an electronic device, cause the electronic device to:
receive one or more positioning signals in accordance with a first comb pattern via resources defined by a set of orthogonal frequency division multiplexing (OFDM) symbols and a first set of subcarriers, wherein the set of OFDM symbols includes one or more OFDM symbols;
generate a single OFDM symbol, wherein generating the single OFDM symbol comprises combining the set of OFDM symbols to form the single OFDM symbol; and
perform a multipath mitigation operation using the single OFDM symbol.
